(19) United States
(12) Patent Application Publication
(10) Pub. No.: US 2025/0215693 A1
(43) Pub. Date: Jul. 3, 2025

(54) RAMPS

(71) Applicant: ENABLE ACCESS (HOLDINGS) LIMITED, Hertfordshire (GB)

(72) Inventor: Gerry MORRISH, Bedfordshire (GB)

(21) Appl. No.: 18/867,244

(22) PCT Filed: May 19, 2023
(86) PCT No.: PCT/EP2023/063501

§ 371 Date: Nov. 19, 2024

(30) Foreign Application Priority Data
May 20, 2022 (GB) 2207444.7
May 20, 2022 (GB) 2207454.6
May 25, 2022 (GB) 2207646.7

(51) Int. Cl. E04F 11/00; B65G 69/30

(52) U.S. Cl. CPC E04F 11/002; B65G 69/30

(57) ABSTRACT

A ramp panel comprising a plurality of longitudinally-elongated ridges spaced in a transverse direction by a plurality of interposed longitudinally-elongated troughs is provided. Each ridge has an upper face defining a portion of a ramp surface over which a ramp user can travel, wherein the height of the ridges on the substrate varies such that the upper faces of the ridges provide a ramp surface having a wave profile in the transverse direction.

### TECHNICAL FIELD

Part of the present disclosure relates to a ramp panel. In particular, the present disclosure relates to ramp panel having an anti-slip ramp surface and a ramp comprising such a panel.

Part of the present disclosure relates to a ramp for facilitating movement between two positions of unequal height. In particular, the present disclosure relates to a ramp hinge system for foldable ramp.

Part of the present disclosure relates to a ramp kerb, a ramp including the ramp kerb, and a method of assembling such a ramp.

### BACKGROUND

It is known to use ramps to facilitate access (e.g., for people in wheelchairs, people with mobility impairments, or people pushing pushchairs/prams) into buildings having one or more steps at the entrance. It is also known to use ramps to facilitate access (e.g., for people in wheelchairs, and/or for people with goods on trolleys) into the back of vehicles.

Ramps typically comprise a ramp panel over which the user can pass from a first end to a second (e.g., higher, or lower) end of the ramp. It is known to configure an upper surface of the panel with an anti-slip surface (e.g., a rubberised, roughened or textured surface) to prevent the user from slipping. Alternatively, the upper surface may comprise a plurality of ridges, or grooves, which extend transversely across the ramp panel and are spaced in a longitudinal direction of the ramp panel.

Despite such known ramp surfaces, there is a need to provide a slip resistant ramp surface which offers greater traction to the ramp user.

Part of the present disclosure aims to provide an improved anti-slip ramp surface.

It is known to use ramps to facilitate movement e.g. for people in wheel chairs, people with mobility impairments, or people pushing pushchairs/prams, between two positions of unequal height. This can be achieved by positioning opposing lateral ends of the ramp respectively at the two positions of unequal height such that the ramp bridges the difference in height. It is also known to use ramps to facilitate access e.g. for people in wheel chairs or for people with goods on trolleys into the back of vehicles.

Some ramps are foldable to facilitate storage and/or transport. Foldable ramps usually comprise two opposing ramp panels each connected by a hinge either to each other or to an interposed central platform/spine. In some known foldable ramps, kerbs are provided on the outer transverse edge of each ramp element, distal to the hinge, to prevent ramp users from exiting the ramp other than via the lateral ends. The hinge allows the ramp to be folded when the ramp is not in use e.g. when the ramp is transported or stored. These ramps are folded with their ramp surfaces (i.e. the surface over which a ramp user travels between lateral ends during use) facing inwardly. Ideally, the kerbs are nested so that one overlays the other in order to make the ramp more compact and easier to store/transport.

A known approach to realising the nesting of the kerbs in the folded position is to provide the ramp with two differently sized ramp panels. In particular, the transverse width (perpendicular to the direction of travel over the ramp of a ramp user) of one panel is greater than the transverse width of the other ramp panel so that the spacing of the two kerbs from the hinge is different.

One problem with this known approach is that manufacture of the two ramp panels requires differently sized manufacturing equipment which increases manufacturing costs and decreases manufacturing efficiency.

The present disclosure has been realised in light of the above considerations.

It is known to use ramps to provide access between two surfaces at different height. Ramps may, for example, be easier to use than stairs for people in wheelchairs, people with mobility impairments, or people pushing pushchairs/prams. It is also known to use ramps to facilitate access e.g. for people in wheelchairs or for people with goods on trolleys into the back of vehicles.

Portable ramps which can be placed at e.g. the entrance to a building or at the back of a vehicle and then removed and stored at an alternative location are known. This type or ramp (and other known types of ramps) typically comprise a ramp member over which a user can pass from a first end to a second (higher or lower) end. Such ramps sometimes include two ramp kerbs, each extending along one of two opposite longitudinally extending edges (extending between the two ends) of the ramp member. One purpose of these ramp kerbs is to increase the safety of the ramp by preventing e.g. wheels of a wheelchair or pushchair/pram from rolling off an edge of the ramp.

In some cases, ramp kerbs may be integrally formed with the ramp member. In other arrangements, the ramp kerbs and ramp surface member may be provided as separate components that are subsequently fixed together to form the ramp. Such fixing can be provided in the form of fasteners, such as screws or rivets, that pass through (e.g. pre-drilled holes in) the ramp kerbs and ramp member to secure them together. While such fixing can provide the necessary structural rigidity required by a ramp, this process can form a significant portion of the time and cost of assembling the ramp.

The present disclosure has been devised in light of the above considerations.

### SUMMARY

In a first aspect, the disclosure provides a ramp panel comprising a plurality of longitudinally-elongated ridges spaced in a transverse direction by a plurality of interposed longitudinally-elongated troughs, each ridge having an upper face defining a portion of a ramp surface over which a ramp user can travel, wherein the height of the ridges on the ramp panel varies such that the upper faces of the ridges provide a ramp surface having a wave profile in the transverse direction.

The ramp panel may comprise a substrate, and the plurality of longitudinally-elongated ridges and the plurality of interposed longitudinally-elongated troughs may be provided on the substrate. Each trough may comprise a base, and the bases of the troughs may define the upper surface of the substrate. The substrate may be planar.

The ramp panel (e.g. the substrate, ridges and troughs) may be of unitary construction.

The ramp panel may comprise a primary ridge having a first height, a secondary ridge having a second height and a tertiary ridge having a third height, the first height being greater than the second height, and the second height being greater than the third height; and the secondary ridge may be interposed between the primary ridge and the tertiary ridge in the transverse direction.

The variation in the heights of the ridges (creating the wave profile) means that there is a variation in both the contact points and the pressure applied to a shoe, foot, or wheel by the ridges in use. In this way, the wave profile provided on the ramp surface offers greater traction to the ramp user thus providing increased slip resistant properties to the ramp surface.

Used herein, ‘longitudinal’ or ‘longitudinally’ in relation to the ridges, means in a length-wise direction of the or each ridge (i.e. in the direction of elongation of the ridges). The term “transverse” is used to mean a direction perpendicular to the longitudinal direction i.e. perpendicular to the elongation of the ridges. The transverse direction defines a width direction of each respective ridge. The height of each ridge may be measured as the spacing from a lower surface of the panel (opposing the ramp surface) to the upper face of the ridge. The heights of the ridges may alternatively be measured from an upper surface of the substrate, the upper surface defined by the bases of the troughs.

Optional features are described below. They are applicable singly or in any in combination in any aspect of the disclosure.

The ramp panel may be an extruded ramp panel, a machined ramp panel or a pressed ramp panel. Advantageously, the ramp panel being extruded or pressed results in reduced material wastage during manufacture compared to, for example, machining.

The first height (that is, the height of the primary ridge) may be a maximum height of the wave profile. The third height (that is, the height of the tertiary ridge) may be a minimum height of the wave profile.

Where a ridge is interposed between two adjacent ridges, said ridge may vary in height from its two adjacent ridges. Accordingly, the height of the wave profile varies continuously from ridge to ridge in the transverse direction, for example, travelling in a transverse direction, the sequence of ridges may be: a primary ridge adjacent a secondary ridge, adjacent a tertiary ridge, adjacent a secondary ridge, adjacent a primary ridge, etc.

In some embodiments, the ridges may extend longitudinally in a direction across the ramp panel that is generally in the direction perpendicular to the direction of travel along the ramp surface by a ramp user (i.e., from a first lateral end of the ramp surface to a second lateral end of the ramp surface). Alternatively, the ridges may extend longitudinally in a direction across the ramp panel that is generally in the direction parallel to the direction of travel along the ramp surface by a ramp user (i.e. from a first lateral end of the ramp surface to a second lateral end of the ramp surface)

The ramp panel may have a substantially planar lower surface opposing the ramp surface.

The ridges are preferably parallel to one another on the ramp panel. The plurality of longitudinally-elongated ridges may each protrude from the ramp panel in a substantially vertical direction i.e. in a direction perpendicular to the longitudinal and transverse directions.

The wave profile of the ramp surface comprises a plurality of peak regions spaced by a plurality of interposed valley regions in the transverse direction. The wave profile of the ramp surface may comprise one or more peak regions, each peak region comprising one or more primary ridges; one or more valley regions, each valley region comprising one or more tertiary ridges; and one or more transition regions, each transition region comprising one or more secondary ridges.

The peak regions may be equally spaced along the transverse direction.

Each peak region may comprise one or more primary ridges, said primary ridges optionally being the maximum height of the wave profile. Each peak region may comprise at least two (for example, two), at least three, at least four or at least five primary ridges. Where a peak region comprises a plurality of primary ridges, these may be adjacent each other within the peak region. Each peak region may comprise one or more further peak region ridges that differ in height from the primary ridge(s) (for example, having a lesser height than the primary ridge(s)).

Each valley region may comprise one or more tertiary ridges, said tertiary ridges optionally being the minimum height of the wave profile. Each valley region may comprise at least two (for example, two), at least three, at least four or at least five tertiary ridges. Where a valley region comprises a plurality of primary ridges, these may be adjacent each other within the valley region. Each valley region may comprise one or more further valley region ridges that differ in height from the tertiary ridge(s) (for example, having a greater height than the primary ridge(s)).

Each transition region may comprise at least two (for example, two), at least three, at least four, or at least five secondary ridges. The secondary ridges within a transition may differ in height from each other, provided that they are between the first height and the third height. Typically, the ridges in the transition region(s) have a greater height than the one or more ridges in valley region(s), Typically, the ridges in the transition region(s) have a lesser height than the one or more ridges in the peak region(s).

Each transition region may be interposed between an adjacent peak region and an adjacent valley region.

By the ramp panel comprising a plurality peak regions, a plurality of valley regions, and a plurality of transition regions, the wave profile may be an undulating profile such that it may define a generally rising and falling profile containing multiple minima and maxima in height. The wave profile (e.g. the undulating profile of the ramp surface) may comprise a continuous undulating profile (i.e. an profile that monotonically or strictly increases in height between a minimum in height and a maximum in height in the transverse direction and monotonically or strictly decreases in height between a maximum in height and a minimum in height in the transverse direction). The transition between a peak region and an adjacent valley region may be made a smooth transition by a transition region being interposed therebetween, such that there is a gradual reduction in the height of the wave profile between the peak region and the valley region (e.g. a transition region wherein the height of the wave profile monotonically or strictly decreases between the peak region and the valley region). For example, the plurality of ridges may be configured such that there is a gradual (e.g. a monotonic or strict) decrease in the height of the ridges from the peak region (and, optionally, the primary peak within that peak region, which may be the ridge with a maximum height within the wave profile), towards the valley region (and, optionally, the tertiary peak within that valley region, which may be the ridge with a minimum height within the wave profile).

The height of the ramp surface may monotonically or strictly decrease in the transverse direction from a primary ridge in a peak region to a tertiary ridge in a valley region.

The ramp panel may comprise a plurality of peak regions, and the wave profile may be symmetrical about a valley region between two peak regions adjacent said valley region.

The ramp panel may comprise a plurality of valley regions, and the wave profile may be symmetrical about a peak region between two valley regions adjacent said peak region.

The wave profile in one or more, or all, of the peak region(s) may be symmetrical. The wave profile in one or more, or all, of the valley region(s) may be symmetrical.

The ramp panel may comprise a plurality of valley regions, and a peak region may be adjacent a valley region in a direction opposite the transverse direction without a transition region interposed therebetween. Accordingly, the wave profile has an asymmetrical shape about said peak region, with the ramp surface being steeper on the side of the peak region in a direction opposite the transverse direction than the ramp surface on the side of the peak region in the transverse direction. That is, the shape of the wave profile (as defined by the tops of the ridges) about the peak region may be asymmetrical such that the profile on one side of the peak region is steeper than the other.

The ramp panel may comprise a plurality of peak regions and each peak region may be adjacent a transition region in the transverse direction and adjacent a valley region in a direction opposite the transverse direction. Accordingly, the wave profile has an asymmetrical shape about each valley region, with the ramp surface being steeper on the side of the valley region in a direction opposite the transverse direction than the ramp surface on the side of the valley region in the transverse direction. In other words, moving along the wave profile in one direction, the ridge heights may gradually increase to the tallest ridge (i.e. the ridge having the greatest height), which may then be followed by the smallest ridge (i.e. the ridge having the smallest height). This may repeat, forming a half-wave or saw tooth pattern.

The ramp surface may comprise a plurality of wave/undulation cycles in the transverse direction. The plurality of wave/undulation cycles may comprise a single wave/undulation cycle which is repeated in the transverse direction. For example, a first wave/undulation cycle may be configured with the same arrangement of ridge heights/widths as a second wave/undulation cycle. Alternatively, the wave/undulation cycles may vary in the transverse direction so as to define a non-repeating undulating profile. For example, a first undulation cycle (e.g. defined by a first plurality of ridges) may be substantially different (e.g. with different heights and/or widths) to a second undulation cycle (e.g. defined by a second plurality of ridges).

The bases of the plurality of the troughs may all be substantially coplanar. In this case, an upper surface of the substrate is planar. In this way, the depth of the troughs from the ramp surface (i.e. from the upper face of the adjacent ridge) may also vary in the transverse direction in the way as the heights of the ridges.

The upper face of each ridge may be substantially planar. Such upper faces of the ridges may also be substantially parallel with each other.

In some embodiments, the spacing (in the height direction) between adjacent upper faces of the longitudinally-elongated ridges varies. For example, the spacing between upper faces of adjacent ridges may increase (e.g. increase gradually) towards the peak region of the wave/undulation and decrease (e.g. decrease gradually) towards the valley region of the wave/undulation.

At least one of the ridges and preferably each ridge, within the plurality of longitudinally-elongated ridges, may have a uniform height along its longitudinal elongation (i.e. along the entire length of the ridge). The length of all of the ridges may be substantially the same.

The maximum width of the ridges may vary in the transverse direction. For example, the maximum width of the ridge(s) in the peak regions may be greater than the maximum width of the ridge(s) in the valley regions. The maximum width may increase (e.g. gradually increase) from the valley to peak regions.

The transverse spacing between the upper faces of adjacent ridges may vary in the transverse direction. For example, the transverse spacing of the upper faces in the peak regions may be greater than the transverse spacing of the upper faces in the valley regions. The width may increase (e.g. gradually increase) from the valley to peak regions. A distance in the transverse direction between a primary ridge and most proximate secondary ridge to the primary ridge may be equal to a distance in the transverse direction between the secondary ridge and most proximate tertiary ridge to the secondary ridge. Alternatively, a distance in the transverse direction between a primary ridge and most proximate secondary ridge to the primary ridge may be different to a distance in the transverse direction between the secondary ridge and most proximate tertiary ridge to the secondary ridge.

Each peak region may comprise a plurality of ridges and the pitch of said plurality of ridges in a given peak region may vary. Alternatively, said pitch may be constant. The plurality of ridges within each peak region may, or may not, all be primary ridges.

Each valley region may comprise a plurality of ridges and the pitch of said plurality of ridges in a given valley region may vary. Alternatively, said pitch may be constant. The plurality of ridges within each valley region may, or may not, all be tertiary ridges.

Each transition region may comprise a plurality of ridges and the pitch of said plurality of ridges in a given transition region may vary. Alternatively, said pitch may be constant.

At least one, or each, of the plurality of longitudinally-extending troughs may be configured with a substantially curved (i.e. concave) transverse cross-sectional profile. For example, at least one, or each, of the troughs may comprise a trough base which is substantially curved e.g. continuously curved. In such a case, an upper surface of the substrate may be defined by the lowest point of each trough base.

The maximum width of the troughs may vary in the transverse direction. For example, the maximum width of the trough(s) in the peak regions may be greater than the maximum width of the ridge(s) in the valley regions. The maximum width may increase (e.g. gradually increase) from the valley to peak regions.

At least one, or each, of the plurality of longitudinally-elongated ridges may comprise a substantially triangular transverse cross-sectional profile. An apex of the triangular cross-sectional profile may define the upper face of the ridge. The apex forming the upper face of the ridge may be substantially rounded or truncated.

Each ridge may have a substantially symmetrical transverse cross-sectional profile or may have an asymmetrical transverse cross-sectional profile.

The ramp surface which is defined by the upper faces of the plurality of longitudinally-elongated ridges, may extend over substantially the entirety of one face (e.g. an upper face of the substrate) of the ramp panel. The longitudinal direction of the ridges may correspond to a substantially transverse direction of the ramp panel. Accordingly, the plurality of longitudinally-extending ridges may extend for the entire width of the substrate/panel (or substantially the entire width of the panel). Such an arrangement may lend itself to manufacture of the ramp panel by way of an extrusion process (e.g., a single step extrusion process).

At least one of the longitudinally-elongated ridges may comprise a series of longitudinally-spaced transverse notches. The notches in the, or each, series may vary in depth along the longitudinal elongation of the respective ridge. Accordingly, the longitudinal-sectional profile of the ridge may vary along the length of the ridge due to the presence of the notches.

A plurality (i.e. at least two or more) of the plurality of longitudinally-elongated ridges may each comprise a respective series of notches. For example, all of the plurality of longitudinally-elongated ridges may comprise a respective series of notches.

Each notch may comprise a respective notch base. The notches within the series of notches (or within each series of notches) may vary in depth such that the bases of the notches together define a wave profile in the longitudinal direction of the ridge.

The notch wave profile comprises a plurality of notch peak regions spaced by a plurality of interposed notch valley regions in the longitudinal direction. The notch peak regions may be equally spaced along the longitudinal direction.

Each notch peak region comprises one or more notches with minimum depth (from the upper face of the ridge). Each notch peak region may comprise at least two, at least three, at least four or at least five notches with minimum depth. Each notch peak region may comprise one or more further notches that differ in depth from the notch(es) with minimum depth.

Each notch valley region comprises one or more notches of maximum depth. Each notch valley region may comprise at least two, at least three, at least four or at least five notches with maximum depth. Each notch valley region may comprise one or more further notches that differ in depth from the notch(es) with maximum depth.

The notch wave profile may further comprise one or more notch transition regions interposed between the notch peak region(s) and notch valley region(s), each notch transition region comprising one or more (e.g. at least two, at least three, at least four, or at least five) notches with an intermediate depth between the minimum depth and the maximum depth.

By a ridge comprising a notch wave profile with a plurality of notch peak regions and notch valley regions, the notch wave profile may be an undulating profile such that it may define a generally rising and falling profile containing multiple minima and maxima in depth. The notch wave profile (e.g. the undulating notch profile) may comprise a continuous undulating profile (i.e. a notch profile that monotonically or strictly increases in depth between a minimum in depth and a maximum in depth in the longitudinal direction and monotonically or strictly decreases in depth between a maximum in depth and a minimum in depth in the longitudinal direction). The transition between a notch peak region and a most proximate notch valley region may be made a smooth transition by a notch transition region being interposed therebetween, such that there is a gradual reduction in depth of the wave profile between the notch valley region and the notch peak region (e.g. a transition region wherein the depth of the wave profile monotonically or strictly decreases between the notch valley region and the notch peak region). For example, the series of notches may be configured such that there is a gradual (e.g. a monotonic or strict) increase in the depth of the notches from the notch peak region towards the notch valley region (e.g. to a notch or notches with a maximum depth) of the profile, before the notch depths reduce gradually (e.g. monotonically or strictly) towards another notch peak region (e.g. to a notch or notches with a minimum depth) of the profile. In some embodiments, each notch may vary in depth from its two adjacent notches.

The/each notch series/wave profile may comprise a plurality of wave/undulation cycles in the longitudinal direction. The plurality of wave/undulation cycles may comprise a single wave/undulation cycle which is repeated in the longitudinal direction. For example, a first wave/undulation cycle may be configured with the same arrangement of notch depths/widths as a second wave/undulation cycle. Alternatively, the wave/undulation cycles may vary in the longitudinal direction so as to define a non-repeating undulating notch profile. For example, a first undulation cycle (e.g. defined by a first plurality of notches) may be substantially different (e.g. with different depths and/or widths) to a second undulation cycle (e.g. defined by a second plurality of notches).

Each notch may extend in the transverse direction across the entire width of the respective ridge(s), so as to form a substantially open channel which connects between the troughs on either side of the ridge.

Each notch may comprise a substantially triangular longitudinal-sectional profile with an apex of the triangle forming the notch base. The apex may be truncated such that each notch base is substantially planar in the transverse and longitudinal directions.

In some embodiments the ramp panel is formed of a metal or a metal alloy (e.g., an aluminium alloy extrusion). In this way, the ramp panel may be particularly cost-effective and fast to manufacture. Alternatively, the ramp panel may be formed of a polymer.

In a second aspect, there is provided a ramp panel comprising a plurality of longitudinally-elongated ridges spaced in a transverse direction by a plurality of interposed longitudinally-elongated troughs, each ridge having an upper face defining a portion of a ramp surface over which a ramp user can travel, wherein at least one of the ridges comprises a series of longitudinally-spaced transverse notches and wherein the notches in the series or each series of notches vary in depth along the longitudinal elongation of the respective ridge.

The ramp panel according to the second aspect also provides increased slip resistant properties for the ramp user. By notching one or more of the ridges with notches of varying depths, an increased variation in the ramp surface profile can provide improved grip to a ramp user.

The features of the notches described above in relation to the first aspect are equally applicable to the second aspect.

Accordingly, it will be appreciated that a ramp panel according to the present disclosure may comprise any one of the above-described features of the first and second aspects, and any combination thereof. For example, the notches of the second aspect may be combined with the ridges of the first aspect to provide a ramp surface which is configured with an undulating profile in both longitudinal and transverse directions. Combining these complimentary undulating profiles may, in certain situations, further enhance the slip-resistant properties of the ramp panel.

In a third aspect, the present disclosure provides a ramp comprising at least one ramp panel as described above (e.g., a ramp panel according to the first and/or second aspects).

Used herein, ‘longitudinal’ or ‘longitudinally’ in relation to the ramp panel, or ramp, means in a length-wise direction of the ramp. This will generally be in the direction parallel to the direction of travel along the ramp surface by a ramp user, (i.e., substantially perpendicular to the longitudinal axis of the plurality of ridges which define at least part of the ramp surface). References herein to ‘transverse’ in relation to the ramp panel, or ramp, mean a direction perpendicular to the longitudinal axis of the ramp panel (i.e., substantially parallel to the longitudinal axis of the ridges). References herein to upper and lower in the context of the ramp panel, or ramp are in relation to the orientation of those components during normal use of the ramp. References herein to a vertical direction in the context of the ramp, or ramp panel, mean a vertical direction when the ramp, or ramp panel, is laid horizontally. In other words, the vertical direction in the context of the present disclosure is the direction normal to an upper surface or face of the ramp surface, along which a user travels during use.

The ramp panel may comprise a first lateral end across which the ramp user enters the ramp, and a laterally opposed second lateral end from which the ramp user exits the ramp. The longitudinally-elongated ridges may extend in a direction perpendicular to the direction extending between the lateral ends. Alternatively, the longitudinally-elongated ridges may extend in a direction parallel to the direction extending between the lateral ends.

The ramp panel may form only a portion of the ramp. For example, the ramp panel may be arranged together with a like ramp panel to form the ramp surface. For example, a plurality of ramp panels (or ramp elements) may be interlocked together to form the ramp. The use of a plurality of ramp panels (as opposed to e.g., a single panel) may also facilitate the manufacture and assembly of ramp surfaces of various lengths. With known ramp surfaces, the provision of ramps of different lengths may require the manufacture of multiple ramp panel ‘versions’ having different lengths. However, the use of ramp panels to form a modular ramp surface means that ramp surfaces of different length can be provided by merely altering the number of ramp panels that make up the ramp surface. In this way, the ramp panels may (in some cases) reduce manufacturing complexity, and thus manufacturing costs.

In some embodiments the plurality of ramp panels may be arranged such that, when the ramp panels are arranged together to form the ramp, the respective upper surfaces (e.g., the ramp surfaces) of the ramp panels are generally coplanar. For example, when the ramp panels are arranged together to form the ramp, the upper surfaces of the ramp panels may form a generally continuous surface.

A plurality, or each, of the panels within the plurality of ramp panels may be configured so that the respective plurality of ridges (e.g., of each ramp panel), together define an undulating profile which extends continuously from one panel to an adjacent panel in the transverse direction of the ridges. In this way, the undulating profile of the ramp surface may extend in a longitudinal direction of the ramp, so as to provide a substantially continuous slip resistant surface for a ramp user to travel across.

In some embodiments, the ramp may comprise two ramp panels or two series of adjacent ramp panels with a longitudinally-extending hinge extending therebetween such that the ramp panels/series of ramp panels may be folded towards each other for transport or storage.

In a fourth aspect there is provided a method of forming a ramp panel as described above (e.g., a ramp panel according to the first and/or second aspects). The method comprises forming a plurality of longitudinally-elongated ridges on a surface of the ramp panel, the plurality of longitudinally-elongated ridges being spaced in a transverse direction by a plurality of interposed longitudinally-elongated troughs.

The method may comprise forming the ramp panel by an extrusion process. The method may comprise extruding the ramp panel in an extrusion direction which is substantially parallel to the longitudinal direction of the plurality of ridges.

The method may comprise forming at least one of the ridges with a series of longitudinally-spaced transverse notches. The method comprises varying the depth of the notches in the series, or each series, along the longitudinal elongation of the respective ridge. The method may comprise forming the plurality of notches by a knurling process. However, other destructive manufacturing processes may also be used (e.g., drilling, milling sawing etc.).

Accordingly, in a fifth aspect, there is provided a hinge system for a foldable ramp, the hinge system comprising:

a first ramp connector comprising a longitudinally-extending first inner channel and an adjacent longitudinally-extending first outer channel;

a second ramp connector comprising a longitudinally-extending second inner channel and an adjacent longitudinally-extending second outer channel; and

a hinge portion interposed between the first and second ramp connectors, the hinge portion having first and second longitudinally-extending hinge pins and a hinge body extending transversely therebetween, wherein:

the first hinge pin is received in the first inner channel and the second hinge pin is received in the second outer channel; and

the hinge pins are pivotable about their respective longitudinal axes inside the respective channels.

By providing a hinge system having two hinge pins which are received within respective connectors (which can each be connected to/integral with a respective inner transverse edge of a ramp panel) in an unsymmetrical arrangement i.e. with one hinge pin in an inner channel of the first ramp connector and the other hinge pin in the outer channel of the second ramp connector, it is possible to use the hinge system with two equally sized ramp panels because in a closed configuration of the hinge system (when the ramp is folded such that the ramp surfaces of the ramp panels face each other) the connectors can face/overlie each other with the inner channels transversely off-set so that the inner transverse edges of the ramp panels are off-set. In turn, this means that the outer transverse edges of the ramp panels and any kerbs thereon are also off-set so that the kerbs can be nested and one (on the ramp panel associated with the second ramp connector) overlays the other (associated with the first ramp connector).

As explained above, this arrangement allows the use of two equally sized ramp panels which reduces manufacturing costs and increases manufacturing efficiency.

Optional features will now be described. These are applicable singly or in any combination with any aspect.

The hinge pins may be pivotable from an open configuration in which the first and second ramp connectors are arranged such that the first and second outer channels are adjacent each other and interposed between the first and second inner channels, to a closed configuration in which the first and second ramp connectors overlie each other with the first inner channel and second inner channel transversely off-set.

In some embodiments, the first and second ramp connectors may be identical. This further reduces manufacturing costs and increases manufacturing efficiency.

Preferred features of the first ramp connector will now be described but it will be appreciated that these features may equally apply to the second ramp connector.

The first ramp connector may comprise a first connector body. The first connector body may be a longitudinally-extending first connector body. The first inner channel may be connected to/integral with the first connector body i.e. the first inner channel may be interposed between the connector body and the first outer channel.

The first connector body may comprise a first recess for receiving an inner transverse edge of a first ramp panel. The first recess may be a longitudinally-extending recess. The first recess may extend substantially parallel to the first inner and outer channels.

The first connector body may comprise an upper portion which, in use, is proximal the ramp surface of the first ramp panel i.e. proximal the surface over which the user travels in use.

The upper portion may comprise a ridged portion. The ridged portion may comprise a series of longitudinally-extending, transversely spaced ridges. The upper portion may comprise a transversely-extending extension from the ridged portion. The transverse extension may be substantially planar and may have a reduced depth (in a direction perpendicular to both the transverse extension and the longitudinal extension) compared to the ridged portion.

The first connector body may comprise a lower portion. The lower portion may extend (longitudinally and/or transversely) substantially parallel to the upper portion. The lower portion may, in use, be proximal the lower surface of the first ramp panel i.e. distal the surface over which the user travels in use.

The upper portion may have a greater transverse extension than the lower portion.

The upper and lower portions of the first connector body may be spaced in a depth direction (i.e. in a direction perpendicular to both the transverse extension and the longitudinal extension of the upper/lower portions) by a side portion. The first inner channel may be connected to (including being integral with) the side portion of the first connector body.

The first connector body e.g. the upper portion, lower portion and side portion of the first connector body and the first inner and outer channels may all be integrally formed e.g. they may be extrusion moulded as a single piece.

Together, the upper, lower and side portions of the first connector body may define the first recess. The recess may be defined by a face of the side portion which opposes the face of the side portion connected to the first inner channel.

The first inner channel may comprise a substantially semi-circular transverse cross sectional profile (transverse to the longitudinal axis of the first inner channel) and have a respective diameter. The first outer channel may comprise a substantially semi-circular transverse cross sectional profile (transverse to the axis of the first outer channel) and have a respective diameter. The first inner and outer channels may be identical. The first inner and outer channels may share a common dividing wall i.e. an outer wall portion of the first inner channel may also form an inner wall portion of the first outer channel.

The first inner channel may comprise a longitudinally-extending first inner channel opening for receipt of the first hinge pin. The first inner channel opening may have a transverse dimension smaller than the diameter of the first inner channel. The first outer channel may comprise a longitudinally-extending first outer channel opening. The first outer channel opening may have a transverse dimension smaller than the diameter of the first outer channel. The first inner and outer channel openings may be aligned with each other in common plane.

A transverse reinforcing rib may extend from the junction between the first lower portion and first side portion of the first connector body. This transverse reinforcing rib may be joined to the first outer channel by an upwardly-depending rib. The first inner and outer channels, first side portion, transverse reinforcing rib and upwardly depending rib may define a longitudinally-extending box structure 502. The upwardly-depending rib may curves inwardly into the box structure. The box structure reinforces the first connector member and protects the outer channel in particular from damage or distortion.

The first lower portion may further comprise a plurality of longitudinally-extending, downwardly-depending strengthening ribs.

The first ramp connector may comprise at least one longitudinally-extending chamfered edge which may be provided on the upper portion of the first connector body. It may be provided on the upper portion of the connector body proximal the first inner channel e.g. proximal the join between the upper portion and side portion of the first ramp connector. The chamfered edge or at least one further chamfered edge may be provided on the dividing wall between the first inner and outer channels e.g. on the dividing wall facing the first outer channel and/or facing the first inner channel. The chamfered edge, the further chamfered edge or a yet further chamfered edge may be provided on the outer edge of the outer channel, facing inwards towards the first outer channel opening.

The first ramp connector may be formed of metal such as aluminium e.g. extruded aluminium.

The hinge portion comprises first and second hinge pins spaced by a hinge body. The hinge pins may be identical. The hinge pins may be spherically cylindrical i.e. they may have a transverse profile (transverse to their longitudinal extension) that is substantially circular and a hinge pin diameter. The hinge pin diameter of each hinge pin may be smaller than the diameter of the respective channel in which it the hinge pin is received and larger than the transverse dimension of the respective channel opening. In this way, each hinge pin may be retained within the respective channel by a snap fit engagement. Each hinge pin may have an axial length which substantially matches that of the connector channel in which they are received.

The hinge body may be a longitudinally-extending hinge body. It may have an upper surface which, in use, is proximal the ramp surfaces over which the user travels in use. The upper surface may comprise a ridged portion. The ridged portion may comprise a series of longitudinally-extending, transversely spaced ridges.

The hinge body may have a lower surface disposed on an opposite face of the hinge body to the upper surface. The lower surface may, in use, be proximal the lower surface of the ramp panels i.e. distal the surface over which the user travels in use.

The hinge portion may comprise a first connecting member connecting the hinge body to the first hinge pin and a second connecting member connecting the hinge body to the second hinge pin. The first and second connecting members may be longitudinally-extending members. The first and second connecting members may be provided on opposing transverse edges of the hinge body. They may each depend substantially downwardly and outwardly from respective transverse edges of the hinge body. The connecting members may each have an internal surface extending from the lower surface of the hinge body and an external surface extending from the upper surface of the hinge body.

The connecting members, e.g. their internal surfaces, may each form an obtuse angle with the hinge body, e.g. with the lower surface of the hinge body. For example, each connecting member may depend downwardly and outwardly from the lower surface e.g. at an angle of between 95-160 degrees such as at an angle of between 110-150 degrees e.g. around 135 degrees from the plane of the lower surface of the hinge body.

The angle of dependence of the connecting members relative to the plane of the lower surface may match the angle of the or each chamfered edge on the first/second ramp connectors i.e. may match the obtuse angle of the chamfered edge relative to the plane of the upper portion of the respective connector body.

The hinge pins, the hinge connecting members and the hinge body may be integrally formed to provide the hinge portion, e.g. by extrusion moulding. The hinge portion may be formed of metal such as aluminium e.g. extruded aluminium.

The hinge portion may be connected (including integrally) to a handle holder for gripping a handle. The handle holder may be connected to the hinge body at the lower surface e.g. proximal to the second hinge pin. In use, the handle holder may extend downwardly away from the lower surface. In the open configuration of the hinge system, the handle holder may be located between the first and second ramp connector e.g. between the first and second connector bodies. It may have a depth dimension (i.e. in a direction perpendicular to the longitudinal and transverse extension of the hinge body) that is less than the depth dimension of the connector body so that the handle holder is entirely within a space defined between the connector bodies.

The handle holder may comprise a stem portion and a gripping portion. The stem portion may connect the gripping portion to the hinge body. The stem portion may extend longitudinally at least partially along the hinge body. The gripping portion may comprise a longitudinally-extending channel having a longitudinally-extending opening for receiving and gripping the handle e.g. by crimping of the gripping portion around a portion of the handle such as a webbing portion of a handle. Thus, the gripping portion may have a substantially semi-circular transverse cross-sectional profile. The handle holder may be integrally formed with the hinge body and may be formed of metal such as aluminium e.g. extruded aluminium.

In the open configuration of the hinge system, the first and second ramp connectors may be substantially coplanar i.e. the longitudinal axes of the channels of the first ramp connector and the channels of the second ramp connector may be substantially coplanar and parallel. The first recess and the second recess may be coplanar. The upper portions of the first and the second ramp connectors, and optionally the upper surface of the hinge body may be coplanar. The lower portions of the first and the second ramp connectors may be coplanar. The internal surface of the first connecting member may abut the chamfered edge of the dividing wall of the first channels proximal the first inner channel. The internal surface of the second connecting member may abut the chamfered edge of the outer edge of the second outer channel.

At least the stem portion of the handle holder may extend between the outer channels of the first and second ramp connectors. The handle holder may extend no further than the connector bodies in a depth direction.

To move the hinge system to the closed configuration, the first hinge pin pivots within the first inner channel e.g. until the external surface of the first connecting member abuts the chamfered edge on the first connector body and the second hinge pin pivots in the second outer channel e.g. until the external surface of the second connecting member abuts the chambered edge of the dividing wall between the second channels facing the outer channel.

In this way, the hinge body is moved into a position where it is substantially normal to the upper surfaces of the connectors.

In the closed configuration, the first and second ramp connectors face each other i.e. the upper surfaces of the connector bodies face each other. The upper surfaces lie in parallel planes spaced from each other in a direction that is perpendicular to both the longitudinal and transverse elongation of the channels. The upper surfaces are spaced by the hinge body of the hinge portion. The second outer channel substantially overlies the first inner channel. The second inner channel overlies the first connector body e.g. the ridged portion of the first connector body. In this way, the first and second inner channels are off-set rather than aligned. The first and second recesses are also transversely off-set. This transverse off-setting of the connector bodies in the closed configuration means that any ramp panels connected to the connectors are also transversely off-set in the closed configuration so that any kerbs on the outer transverse edges of the ramp panels can be off-set and nested.

In the closed configuration, the handle holder may be exposed such that the gripping portion extends beyond the second channels in a direction parallel with the upper surfaces of the connector bodies, such that a user can conveniently access the gripping portion e.g. to attach the handle thereto.

In a sixth aspect, there is provided a foldable ramp for facilitating movement between two positions of unequal height, the foldable ramp comprising:
a first ramp panel having an inner transverse edge;
a second ramp panel having an inner transverse edge; and
a hinge system according to the fifth aspect interposed between the inner transverse edges of the first and second ramp panels with the inner channel of the first ramp connector connected to or integral with the first ramp panel and the second inner channel of the second ramp connector connected to or integral with the second ramp panel.

In some embodiments, the first and second ramp panels may be identical. Preferred features of the first ramp panel will now be described but it will be appreciated that these features may equally apply to the second ramp panel.

The inner transverse edge of the first ramp panel may be received by the first recess of the first connector body of the hinge system. The first ramp panel may comprise a first ramp surface, i.e. the surface over which the user travels in use. The first ramp surface may comprise a ridged portion. The ridged portion may comprise a series of transversely-extending, longitudinally spaced ridges (perpendicular to the direction of travel of the user on the ramp).

The first ramp panel may comprise an outer transverse edge. The first ramp panel may comprise a first kerb. The first kerb may be integrally formed with the first ramp panel. Alternatively, the first kerb may be connected to the outer transverse edge of the first ramp panel. The first kerb may have a first kerb portion upstanding perpendicularly from the ramp surface and a first kerb connector for connecting to the outer transverse edge. The first kerb connector may comprise a longitudinally-extending kerb recess for receiving the outer transverse edge of the first ramp panel.

The first ramp panel may have longitudinally spaced lateral edges. The lateral edges may each be provided with an inclined lip portion extending downwards in an in-use depth direction.

In the open configuration of the hinge system, the ramp panels may be coplanar. The ramp panels may be coplanar with the hinge body of the hinge system. The kerb portions of the kerbs may be substantially parallel.

In the closed configuration of the hinge system (when the ramp is folded), the ramp panels may be substantially parallel and transversely off-set. The ramp surfaces may face each other. The inner transverse edges of the ramp panels may be transversely off-set. The outer transverse edges of the ramp panels may be transversely off-set. The kerb portions of the kerbs may be substantially parallel and transversely off-set such that they nest against each other. The kerb portions may be substantially parallel to the hinge body.

In a seventh aspect, there is provided a kit of parts comprising:
the hinge system according to the fifth aspect and two ramp panels as described above for the sixth aspect.

In some embodiments, the kit further comprises two kerbs, each attachable to the outer transverse edge of the respective ramp panel.

In some embodiments, the kit further comprises
a handle attachable to a handle holder of the hinge system.

In some embodiments, the handle may comprise a handle grip portion interposed between handle webs. The handle grip portion may be formed a plastics material e.g. a hard plastics material. The handle webs may be flexible webs e.g. formed of a woven textile material. The handle webs may be for insertion within and gripping by the gripping portion of the handle holder.

In a eighth aspect, there is provided a method of manufacturing the foldable ramp of the sixth aspect, the method comprising the steps of:
manufacturing the first ramp panel having a first transverse dimension;
manufacturing the second ramp panel having a second transverse dimension, the second transverse dimension being equal to the first transverse dimension;
providing the hinge system according to the fifth aspect;
fitting the inner transverse edge of the first ramp panel into a first recess of the first ramp connector;
fitting the inner transverse edge of second ramp panel into a second recess of the second ramp connector;
fitting the first hinge pin into the first inner channel of the first ramp connector; and
fitting the second hinge pin into the second outer channel of the second ramp connector.

The method may include manufacturing the ramp panels (e.g. ramp panels as described above for the sixth aspect) using the same manufacturing equipment, e.g. the same extrusion die. The ramp panels may be manufactured as a multiple e.g. double length panel that is then cut into two (or more) ramp panels.

The method may include manufacturing the hinge portion e.g. manufacturing an integral hinge portion using extrusion moulding.

The method may include manufacturing each of the ramp connectors, e.g. by integrally manufacturing respective connector bodies and channels of each of the ramp connectors. The method may include manufacturing the ramp panels and/or the hinge portion and/or the ramp connectors by extrusion moulding.

The method may include manufacturing kerbs (e.g. by extrusion moulding) for connection to the ramp panels. Additionally or alternatively, the method may include fitting a kerb onto an outer transverse edge of each ramp panel, the outer transverse edge being transversely spaced from the inner transverse edge. For example, this may include connecting the respective outer transverse edge to a kerb connector of the respective kerb, e.g. by inserting the outer transverse edge into a respective longitudinally-extending recess. Alternatively, the method may include integrally forming the kerbs with the ramp panels, e.g. by extrusion moulding.

The method may comprise a step of fitting a handle to a handle holder connected (including integrally) to the hinge system. For example, this may involve inserting handle webs (as described above for the seventh aspect) into a gripping portion of the handle holder and securing them therein, e.g. by crimping.

The method may include fitting lip portions to longitudinally spaced lateral ends of each of the ramp panels. For example, this may include inserting the lateral ends of the ramp panels into respective lip recesses of the lip portions. Alternatively, the method may include integrally manufacturing the lip portions with the ramp panels. The lip portions may be inclined with respect to the planes of the ramp panels, such that in use, the lip portion extend downwards in a depth direction.

At its most general, part of the present disclosure relates to a ramp kerb that is configured so that it can be assembled with a ramp member using a process which requires both sides of a flange of the ramp kerb to be accessible (by fixing the ramp member to a flange of the ramp kerb).

In a ninth aspect there is provided a ramp kerb comprising a longitudinally extending spine and first and second flanges projecting laterally from the spine, the flanges spaced from one another so as to define a channel therebetween for supporting a longitudinally extending edge of a ramp member therein, wherein a distal end portion of the first flange projects laterally beyond a distal end of the second flange, and wherein an axis passing through the distal end portion of the first flange, and that is perpendicular to the lateral extension of the first flange, does not intersect any portion of the ramp kerb other than the first flange.

The arrangement of the distal end portion of the first flange in this way means that access is provided to opposing sides of the distal end portion of the first flange (i.e. access is not obstructed by any other part of the ramp kerb). This can be advantageous when assembling the ramp kerb to e.g. a ramp member (i.e. the part of the ramp upon which users may be supported). This is especially the case where such fixing requires both opposing surfaces of the flange to be accessible.

One example of a fixing that requires such access is a self-piercing rivet. Use of a self-piercing rivet involves positioning a punch (and the self-piercing rivet) on one side of two adjacent workpieces to be fixed (e.g. the first flange and an edge of a ramp member) while providing a die on the opposite side of the two workpieces. Of course, access must be provided on both sides of the workpieces for the punch and the die. The rivet is then driven into the two workpieces by the punch so as to pierce one of the two workpieces while deforming the other (such deformation being controlled by the shape of the die). In the resulting arrangement, an annular piercing element of the rivet is flared and embedded in the workpieces so as to fix the workpieces together. As may be appreciated, this process is both quick and inexpensive, at least partly because the fixing is provided in a single movement without the need to first form a hole for receipt of a fastener.

Another example is a clinch fixing formed by a clinching process. This process again involves a punch and a die, except in this case there is no rivet required. Instead, the punch and die are configured so that when the two workpieces are punched, portions of both workpieces are deformed so as to interact with one another. In particular, a portion of one workpiece is received in a portion of the other workpiece so they interlock. In some case, this can simply be in the form of a protrusion in one workpiece received in a recess of the other workpiece (in which case resistance to in-plane movement is provided, but not necessarily resistance of the pieces away from one another). In other arrangements the deformation may be such that a portion of one or both of the workpieces flares outwardly. The flared portion of the workpiece closest to the punch can be received within (i.e. be enveloped by) the flared portion of the other workpiece, which retains the workpieces together. The provision of a join without needing a fastener (such as a rivet) can reduce the cost of assembling a ramp.

As set forth above, the arrangement of the ramp kerb of the ninth aspect permits use of this type of process in assembly and, accordingly, the ramp kerb of the ninth aspect may provide for faster and more cost-effective assembly of a ramp including the ramp kerb.

For the avoidance of doubt, the term “distal” is used to describe the end of each flange that is distal from the spine. The proximal end of each flange is the end at which the flange is connected to the spine (i.e. the end from which the flange extends).

Optional features of the ninth aspect will now be set out. These are applicable singly or in any combination with any aspect.

The first flange may have an external surface that faces in a direction away from the second flange. The first flange may have an internal surface (opposite the external surface) that faces in a direction towards the second flange. Likewise, the second flange may have an external surface that faces in a direction away from the first flange. The second flange may have an internal surface (opposite the external surface) that faces in a direction towards the first flange.

The portion of external surface at the distal end portion of the first flange (i.e. an external surface of the distal end portion) may be substantially planar. This may aid in fixing of the first flange to a ramp (e.g. using the self-piercing rivet or clinching process described above). The portion of the internal surface at the distal end portion of the first flange (i.e. an internal surface of the distal end portion) may be substantially planar. Again, this may aid in fixing the first flange to a ramp (e.g. using the self-piercing rivet process described above).

Thus, the distal end portion of the first flange may be defined between two substantially planar parallel surfaces (one facing away from the second flange and one facing towards the second flange).

The distal end portion of the flange may be configured for fixing by self-piercing rivet or clinching. Preferably, for example, the distal end portion of the flange is solid (e.g. does not include any internal cavity or recess). Having such a cavity could otherwise interfere with the process of fixing the flange to a ramp by such methods.

The distal end portion of the first flange may have a width dimension defined as the distance the first flange extends laterally beyond the distal end of the second flange (i.e. a lateral distance between the distal end of the first flange and the distal end of the second flange). The width of the distal end portion may be at least 8 mm, or e.g. at least 10 mm, or e.g. at least 14 mm (e.g. about 16 mm). In some cases, the width may be larger (for example to allow for double or staggered fixings as discussed further below). In such embodiments, the width may be e.g. more than 30 mm, or more than 40 mm, or more than 50 mm. The width of distal end portion may be less than 100 mm or less than 80 mm.

The first and second flanges may be substantially parallel to one another. One or both of the first and second flanges may extend substantially perpendicularly to the spine.

The first and second flanges may be spaced from one another by a distance of between 5 mm and 25 mm, or between 10 mm and 20 mm, or between 10 mm and 15 mm, or about 11 mm (i.e. this distance defining the height of the channel formed between the flanges). In other versions of the ramp kerb (e.g. such as a heavy duty version), the distance may be between 10 mm and 50 mm, or between 20 mm and 40 mm, or about 30 mm. These embodiments may be particularly suited for ramp kerbs used with ramp members of the type that include legs (as discussed further below).

In other embodiments, however, the ramp kerb may be suited for a ramp member that is formed of a single sheet (i.e. is planar). In this case, the first and second flanges may be spaced from one another by a distance of e.g. less than 5 mm, e.g. about 2 mm.

The first flange may be an in-use upper flange (i.e. may be above the second flange in use, which may be a lower flange). Such an arrangement may be desirable because it may be preferable to arrange the ramp member (to which the first flange is fixed), and thus the surface upon which user's are supported, at the upper flange.

Alternatively, the first flange may be an in-use lower flange (i.e. may be below the second flange in use, which may be an upper flange).

The ramp kerb may comprise a longitudinally extending, upstanding rail. The rail may upstand from, or proximate to, the first or second flange (e.g. whichever is the in-use upper flange of the two flanges). For example, the rail may upstand from or proximate to the proximal end of the first or second flange.

The external surface of the first or second flange (e.g. whichever is the in-use upper flange of the two flanges) may comprise a plurality of longitudinally extending ridges. The plurality of longitudinally extending ridges may be disposed at or proximate to a proximal end of the respective flange. Where the ridges are formed on the first flange, the ridges may be spaced from the distal end portion of the first flange (e.g. so as not to interfere with fixing of the first flange to a ramp member).

The ramp kerb may comprise a longitudinally extending support rib. The rib may project downwardly (in use) from, or proximate to, the spine. The support rib may provide additional support to the ramp kerb (e.g. particularly in embodiments in which the rail is not provided).

One or both flanges may be integrally formed with the spine. The ramp kerb may have a constant cross-sectional shape for substantially its entire length (i.e. in the longitudinal direction). Thus, the ramp kerb may be formed by extrusion. The ramp kerb may, for example, be formed of aluminium (e.g. extruded aluminium). In other embodiments, the ramp kerb may be formed of steel (e.g. rolled steel, steel tube), pultruded polyurethane, fibreglass, etc.

In a tenth aspect there is provided a ramp comprising a ramp kerb according to the ninth aspect and a ramp member having a longitudinally extending edge supported within the channel of the ramp kerb.

Optional features of the tenth aspect will now be set out. These are applicable singly or in any combination with any aspect.

The ramp member may comprise a ramp panel (e.g. forming a main body of the ramp member) having an upper surface upon which a user may be supported in use. The ramp member may also comprise legs projecting downwardly from the ramp panel (e.g. each leg projection downwardly to a distal free end of the leg). Each leg may extend laterally across ramp member (e.g. the legs may be substantially parallel and may be perpendicular to the ramp kerb). The legs may be integrally formed with the ramp member.

The ramp member may be configured such that the axis of the ramp kerb, passing through the distal end of the first flange, intersects only the ramp panel of the ramp member (e.g. does not intersect any legs of the ramp panel). That is, the ramp may be arranged (i.e. the ramp kerb and ramp member may be arranged) such that the axis extending through the distal end portion of the first flange (that is perpendicular to the lateral extension of the first flange), intersects only the first flange and the ramp panel. Hence, the ramp may be arranged such that when received in the channel, a clear path is provided to (the underside of) a portion of the panel member that is adjacent to the distal end portion of the first flange.

The legs may be spaced from one another in the longitudinal direction. The spacing between each pair of two neighbouring legs may be at least 10 mm, e.g. at least 15 mm. The spacing may be at most e.g. 120 mm, or 100 mm. For example, the spacing may be between 30 mm and 80 mm, or between 40 mm and 70 mm, (or about 45 mm, or about 70 mm). The spacing may ensure that, when the ramp member is received in the channel, the legs do not interfere with fixing of the ramp member to the ramp kerb (i.e. the spacing ensures that one or more portions of the ramp panel adjacent the distal end portion of the first flange are accessible for fixing).

In some embodiments the legs maybe primary legs and one or more secondary legs may be provided interposed between neighbouring pairs of primary legs. The secondary legs may be shorter than the primary legs. The secondary legs may be configured to provide additional support to the ramp panel.

As may be appreciated, the longitudinally extending edge of the ramp member may be defined by both the legs and the ramp panel. That is, a portion of each of the ramp panel and each of the legs may be received in the channel of the ramp kerb.

In this way, the upper surface of the ramp panel may abut the internal surface of the first flange (i.e. the surface of the first flange partly defining the channel). The upper surface of the ramp panel that abuts the first flange may be substantially planar (which may provide a closer fit between the upper surface of the ramp panel and the internal surface of the first flange).

Likewise, a distal (e.g. lower) end of each leg may abut an internal surface of the second flange (i.e. the surface of the second flange partly defining the channel). A height of the channel may be substantially the same as a height of the ramp (i.e. the distance between the distal end of a leg of the ramp and the upper surface of the ramp member).

The ramp member may have a constant cross-sectional shape along at least one of its axis (e.g. such as is width). For example, when the legs extend laterally, a cross-sectional shape of the ramp member taken in a longitudinally extending plane may be constant for the width of the ramp member. This may allow the ramp member to be formed by way of an extrusion process.

The first flange of the ramp kerb may be fixed to the ramp panel by way of a plurality of clinch fixings (i.e. in which portions of each of the first flange and ramp panel are deformed so as to be held together) or by way of a plurality of self-piercing rivets.

Thus, for example, when the ramp kerb is fixed to the ramp member by way of clinch fixings, one of the first flange and the ramp member (e.g. ramp panel) may comprise a deformed portion forming a recess and the other of the first flange and the ramp member may comprise a deformed portion forming a protrusion received in the recess. In some cases, each of the recess and protrusion may flare or splay outwardly (i.e. such that a distal end of the protrusion is enlarged and the recess envelopes this enlarged portion). Such an arrangement may be configured such that movement of the first flange and ramp member away from one another (e.g. perpendicular to the planes of the first flange and ramp member) is resisted.

Alternatively, the protrusion/recess may not be flared/splayed. For example, the protrusion and recess may each be hemispherical shaped, or a half-shear clinch may be provided. In such arrangements the fixing may only resist in-plane movement. Nevertheless, such fixing may be sufficient where the longitudinally extending edge of the ramp member fits closely within the channel of the ramp kerb (because such close fit will provide resistance to movement of the ramp member away from the first flange).

The ramp kerb may be a first ramp kerb and the ramp may comprise a second ramp kerb. The second ramp kerb may be substantially the same as the first ramp kerb. The longitudinally extending edge of the ramp member received in the channel of the first ramp kerb may be a first longitudinally extending edge and the ramp member may comprise a second longitudinally extending edge opposite the first longitudinally extending edge. The second longitudinally extending edge may be received in the channel of the second ramp kerb.

The ramp may be a portable ramp. That is, the ramp may be of the type that can be positioned for use and then subsequently removed and stored at an alternative location. The ramp may be a folding ramp (e.g. comprising a longitudinally extending hinge in the ramp member) or maybe non-folding. The ramp may also be non-portable (e.g. may be in the form of a permanent structure).

In a eleventh aspect there is provided a method for assembling a ramp (e.g. of the tenth aspect), the method comprising:
inserting a longitudinally extending edge of a ramp member into the channel of a ramp kerb according to the ninth aspect;
positioning one of a die and a punch on a surface of the distal end portion of the first flange of the ramp kerb;
positioning the other of the die and punch on a surface of the ramp member opposing the surface of the first flange on which the die/punch is positioned;
actuating the punch to punch and deform the first flange and the ramp member to fix the first flange and the ramp member together.

Optional features of the eleventh aspect will now be set out. These are applicable singly or in any combination with any aspect.

The surface of the first flange on which the die or punch is positioned may be an external surface of the first flange (i.e. facing away from the second flange).

The surface of the ramp member on which the other of the die or punch is positioned may be a surface of the ramp panel (e.g. an underside surface of the ramp panel).

The method may comprise, when actuating the punch, driving a self-piercing rivet into the first flange and the ramp member to fix the first flange and the ramp member together.

The die may comprise moveable portions (e.g. arms) that are configured to move outwardly (in a direction radially outwardly from the punch) as the punch is actuated in order to form a clinch fixing.

The method may be repeated one or more times at locations spaced along a length (in the longitudinal direction) of the ramp kerb.

### DESCRIPTION OF DRAWINGS

Embodiments of the disclosure are set out below in detail, with reference to the accompanying drawings, in which:

FIG. 1 is a perspective view of a ramp according to an embodiment of the disclosure;

FIG. 2 is a perspective view of a ramp panel according to an embodiment of the disclosure;

FIG. 3 is a section view of a portion of the ramp panel shown in FIG. 2;

FIG. 4 is a section view of a ridge of the ramp panel shown in FIG. 2, the ridge comprising a plurality of notches according to an embodiment of the disclosure;

FIG. 5 is section view of an alternative ramp surface of a ramp panel according to an embodiment of the disclosure;

FIG. 6 is detailed section view of a ramp surface of the ramp panel shown in FIG. 5;

FIG. 7 is a detailed section view of a further alternative ramp surface of a ramp panel according to an embodiment of the disclosure;

FIG. 8 is a front sectional view of components of a hinge system according to an embodiment of the present disclosure;

FIGS. 9A to 9C show front sectional views of the hinge system transitioning from an open configuration to a closed configuration;

FIG. 10 is a bottom view of a handle holder and a handle;

FIG. 11 is a perspective view of a foldable ramp having the hinge system as configured in FIG. 9A;

FIG. 12 shows a reinforced ramp connector.

FIG. 13A is a front section view of a ramp;

FIG. 13B is a side section view of the ramp of FIG. 13A;

FIGS. 14A and 14B are schematic views illustrating a self-piercing rivet fixing process;

FIGS. 15A and 15B are schematic views illustrating a clinching fixing process; and

FIGS. 16A and 16B are front and side section views of an exemplary clinching fixing.

### DETAILED DESCRIPTION

The following detailed description of embodiments of the present disclosure is made by way of example.

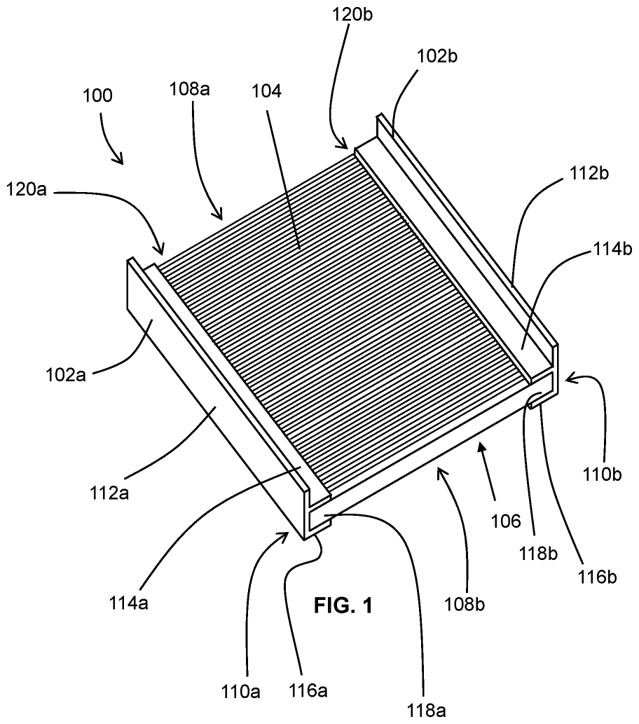

The ramp 100 shown in FIG. 1 comprises two spaced ramp kerbs 102a, 102b supporting a ramp panel 106 having a ramp surface 104.

The ramp panel 106 comprises two lateral ends 108a, 108b that, in use, are supported on separate surfaces (usually at different heights) to allow a user of the ramp structure 100 to traverse from one surface to the other.

The transverse edges 110a, 110b of the ramp panel 106, which extend between the two ends 108a, 108b, are supported by the two ramp kerbs 102a, 102b, such that the ramp panel 106 spans the gap formed between two kerbs 102a, 102b.

Each of the ramp kerbs 102a, 102b is generally elongate and comprises a longitudinally extending spine 112, 112b and two parallel spaced upper 114a, 114b and lower 116a, 116b flanges extending perpendicularly from the spine 112a, 112b. Each of the spine 112a, 112b and upper 114a, 114b and lower 116a, 116b flanges extend for the length of their respective ramp kerb 102a, 102b such that each ramp kerb 102a, 102b has a generally continuous profile. In this respect, the ramp kerbs 102a, 102b may be produced by a single-step manufacturing process, such as extrusion. For example, the ramp kerbs 102a, 102b may be in the form of aluminium extrusions.

The parallel upper 114a, 114b and lower 116a, 116b flanges of each ramp kerb 102a, 102b define an elongate channel 118a, 118b, which also extends for the length of its respective ramp kerb 102a, 102b. When the ramp structure 100 is assembled, these channels 118a, 118b each receive a respective transverse edge 110a, 110b of the ramp panel 106 so as to support the edges 110a, 110b of the ramp panel 106. The spacing of the upper 114a, 114b and lower 116a, 116b flanges (i.e., the height of each channel 118a, 118b) is generally equivalent to the height of a ramp panel 106, such that the ends 120a, 120b of the ramp panel 106 fits closely or snugly within the channels 118a, 118b.

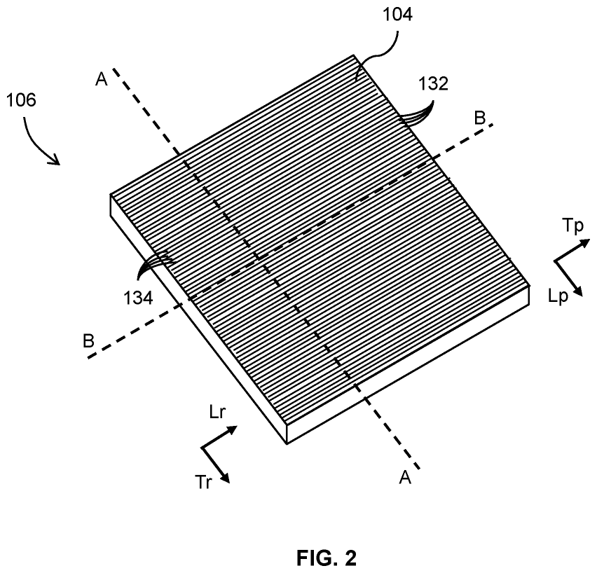

The ramp panel 106 will be described in more detail below with reference to FIGS. 2 to 6. In particular, FIG. 2 shows the ramp panel 106 in isolation (i.e., separated from the kerbs 102a, 102b of the ramp 100).

The ramp panel 106 is formed of a metal (e.g., an aluminium extrusion). The ramp panel 106 comprises a generally rectangular ramp surface 104 upon which a load (e.g., a user of the ramp surface 104) is supported in use. The ramp surface 104 extends in longitudinal (Lp) and transverse (Tp) directions of the panel 106 (as indicated by the respective arrows shown in FIG. 2).

The ramp surface 104 may be modified for the purpose of increasing the friction of the surface 104 (so as to provide grip to a user). In particular, the ramp panel 106 comprises a plurality of longitudinally-elongated ridges 132 spaced apart by a plurality of interposed longitudinally-elongated troughs 134, the ridges 132 and troughs 134 provided on a substrate. Each of the plurality of ridges 132 extends in a longitudinal direction of the ridge 132 (which is indicated by the arrow labelled Lr, as shown in FIG. 2). The ridges 132 are spaced apart by the troughs 134 in a transverse direction of the ridges (as indicated by the arrow labelled Tr). Accordingly, it will be appreciated that the longitudinal direction of the ridges Lr is substantially perpendicular to the longitudinal direction of the panel Lp, and the transverse direction of the ridges Tr is substantially perpendicular to the transverse direction of the panel Tp.

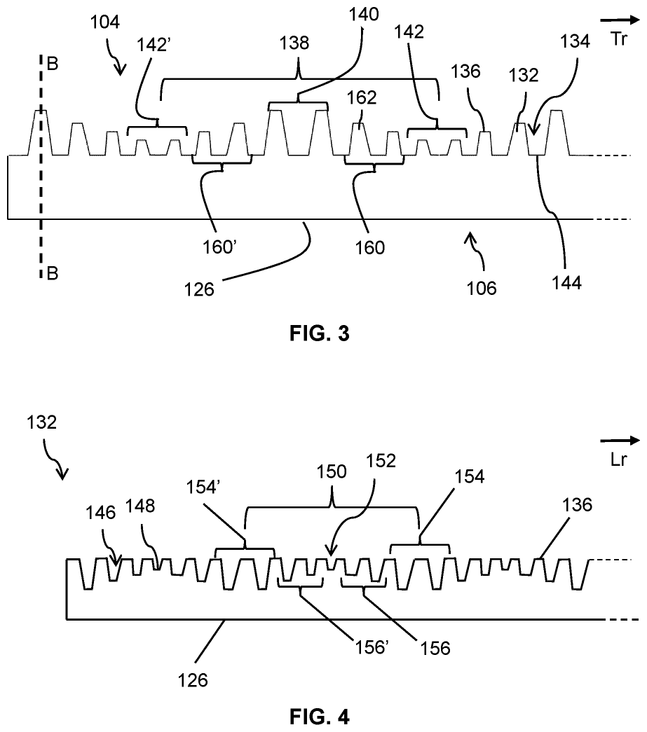

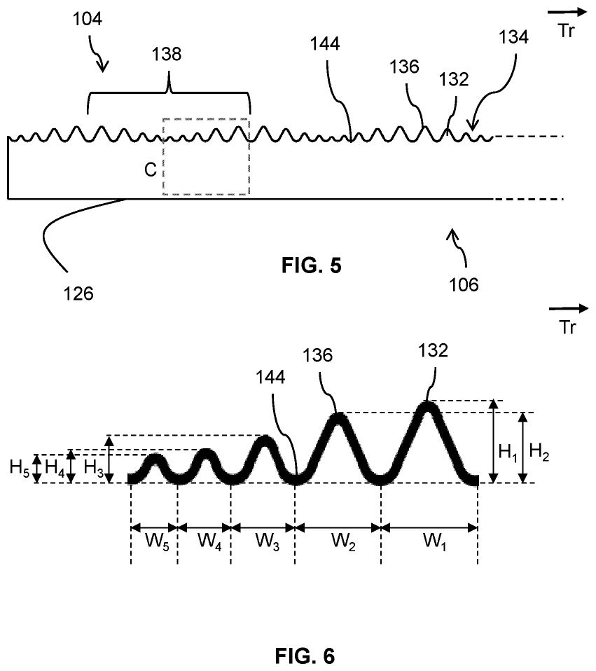

The ramp surface 104 of the ramp panel 106 will be described in more detail below with reference to FIGS. 3 and 4, which show sectional views of the ramp panel 106.

FIG. 3 shows a section taken along the longitudinal direction Lp of the panel 106, which is also the transverse direction Tr of the ridges and troughs 132, 134 (as indicated by the dotted line A-A, shown in FIG. 2).

Each of the plurality of ridges 132 has an upper face 136 defining a portion of the ramp surface 104 over which a ramp user can travel. The height of the ridges 132 i.e. the spacing between the upper faces 136 and the lower surface 126 of the ramp panel 106 vary in order to define an undulating, wave profile of the ramp surface 104 in the transverse direction Tr.

As is clearly shown in FIG. 3, the undulating profile 138 defines a generally rising and falling profile, which comprises a sequence of 8 adjacent ridges 132. Specifically, the height of the undulating profile 138 strictly increases between a minimum height ridge and a maximum height ridge along the profile in the transverse direction, and the height of the undulating profile 138 also strictly decreases between a maximum height ridge and a minimum height ridge along the profile in the transverse direction.

In this instance, the undulating profile 138 is defined as being between a first valley region 142 and a second valley region 142′ of the sequence of the ridges 132, with a peak region 140 interposed therebetween. The peak region 140 comprises two primary ridges having a first height that, in this case, is the maximum height of the profile 138. Interposed between the first valley region 142 and the peak region 140 is a first transition region 160. The first transition region 160 comprises a secondary ridge 162 having a second height, the second height being less than the first height of the primary ridges. The valley regions 142, 142′ each comprise two tertiary ridges having a third height that, in this case, are the minimum height of the profile 138. The third height is less than the second height of the secondary ridge 162 in the first transition region 160. In this instance, the first transition region 160 also comprises a further secondary ridge that interposed between secondary ridge 162 and the first valley region 142, the further secondary ridge having a height that is intermediate the height of secondary ridge 162 and the third height.

A second transition region 160′ is also present within the undulating profile 138, interposed between the peak region 140 and the second valley region 142′ and configured in the same manner as the first transition region 160.

The transition regions 160, 160′ between the peak and valley regions 142′, 140, 142 provide a smooth (and in this case, strict i.e. continuously changing) transition in profile height between said regions. As such, the ridges 132 are configured so that there is a gradual (i.e. monotonic) increase in the height of the ridges 132 between the second valley region 142′ and the peak region 140 (which contains two ridges having a maximum height). The heights of the ridges 132 then reduce gradually (i.e. monotonically) between the peak region 140 and the first valley region 142 (which contains two tertiary ridges which have a minimum height of the profile).

The changes in the undulating profile 138 are gradual and continuous. That is, within the transition regions 160, 160′, the profile 138 is strictly increasing or decreasing (i.e. two ridges adjacent a ridge within the transition region differ in height from that ridge).

The ramp surface 104 comprises a plurality of undulations in the transverse direction Tr. That is, the undulating profile 138 is configured to repeat in the transverse direction of the ridge (i.e., the longitudinal direction of the ramp panel Lp). Accordingly, each of the plurality of the ridges 132 that define the first undulation of the undulating profile 138 is matched to a corresponding ridge 132 of a second undulation of the profile 138, as the undulations are repeated in the transverse direction of the ridge Tr.

Interposed between each pair of ridges 132 is a longitudinally-extending trough 134. Each trough 134 has a longitudinally-extending trough base 144 (which extends parallel to the longitudinal direction of the adjacent ridge 132). The trough bases 144 are all substantially coplanar and define an upper surface of the substrate.

According to this exemplary arrangement, the plurality of ridges 132 each have truncated triangular cross-sectional profile. Each of the planar upper faces 136 extends substantially in both longitudinal and transverse directions of the ridge Lr, Tr. In addition, each of the planar upper faces 136 are non-coplanar (with the exception of the two ridges 132 at the peak region 140 and the two ridges at the valley regions 142, 142′) but substantially parallel to each other, and also parallel to the plane defined below by the trough bases 144.

FIG. 4 shows a sectional view of the panel 106 taken along the transverse direction Tp of the panel 106, which is also the longitudinal direction Lr of the ridges 132 and troughs 134 (as indicated by the dotted line B-B, shown in FIG. 2).

The longitudinally-extending ridge 132 shown in FIG. 4 includes a series of longitudinally-spaced transverse notches 146. The notches 146 vary in depth from the upper face 136 of the ridge 132 along the longitudinal elongation of the ridge 132 (e.g., in the longitudinal direction of the ridge Lr, and the transverse direction of the ramp panel Tp).

According to an exemplary arrangement, each of the ridges 132 shown in the ramp panel 106 of FIG. 2 may be configured with a respective series of notches 146 as shown in FIG. 4. Alternatively, only some of the ridges 132 may have notches 146, and in some embodiments all of the ridges 132 may be notch free.

With particular reference to FIG. 4, the notches 146 each comprise a respective notch base 148. The notch bases 148 of adjacent notches 146 are non-coplanar, such that the adjacent notches 146 have different depths. In particular, the notch bases 148 vary in depth such that they define an undulating notch profile 150 in the longitudinal direction Lr of the ridge 132.

The undulating notch profile 150 defines a generally rising and falling wave profile which comprises a sequence of 7 adjacent notches 146. Specifically, the depth (i.e. the distance from the from the upper face of the ridge to the notch bases 148) of the undulating notch profile 150 strictly decreases between a notch of maximum depth and a notch of minimum depth along the profile 150 in a longitudinal direction, and the depth of the notch profile 150 strictly increases between a notch of minimum depth and a notch of maximum depth along the profile 150 in a longitudinal direction.

The changes in the undulating notch profile 150 are gradual and continuous.

The undulating notch profile 150 includes a notch peak region 152 and notch valley regions 154, 154′. The notch peak region 152 comprises one notch of minimum depth (from the upper face of the ridge). The notch valley regions 154, 154′ each comprise two notches of maximum depth. Interposed between the notch peak region 152 and each notch valley region 154, 154′ is a notch transition region 156, 156′. Each notch transition region 156, 156′ comprises two notches with intermediate depths between the minimum notch depth in the notch peak region 152 and the maximum notch depth in the notch valley region 154, 154′.

The notch transition regions 156, 156′ between the peak and valley regions 154′, 152, 154 provide a smooth (and in this case, strict, i.e. continuously changing, transition in notch profile depth between said region. As such, the notches 146 are configured so that there is a gradual (i.e. strict) decrease in the depth of the notch bases 148 towards the peak region 152 (to one notch having a maximum height). The depths of the notch bases 148 then reduce gradually (i.e. monotonically) towards the valley regions 154, 154′ to two notches of maximum depth.

The changes in the undulating notch profile 150 are gradual and continuous. That is, within the notch transition regions 156, 156′, the notch profile depth is strictly increasing or decreasing (i.e. two notches adjacent a notch within the notch transition region differ in depth from that notch).

Similarly to the transverse undulating profile 138 described above, the longitudinal undulating profile 150 is also configured to repeat across the ramp surface 104. In this case, the undulating profile 150 is repeated in the longitudinal direction of the ridge (i.e., the transverse direction of the ramp panel Tp). Accordingly, each of the plurality of the notches 146 that define the first undulation of the undulating profile 150 is matched to a corresponding notch 146 of a second undulation of the profile 150, as the undulations are repeated along the ridge 132.

Each of the notches 146 has a substantially trapezoidal longitudinal-sectional profile, as is clearly shown in FIG. 4.

In particular, the longitudinal-sectional profile of each notch 146 defines an inverted truncated triangle, with the substantially planar notch base 148 forming the truncated apex of the inverted triangle. Accordingly, each of the planar notch bases 148 is configured to extend in both the transverse and longitudinal directions of the ridge Tr, Lr. In particular, the notch bases 148 extend across the entire width of the ridge 132 (i.e., in the transverse direction Tr), so as to form a substantially open channel which connects between the troughs 134 on either side of the ridge 132.

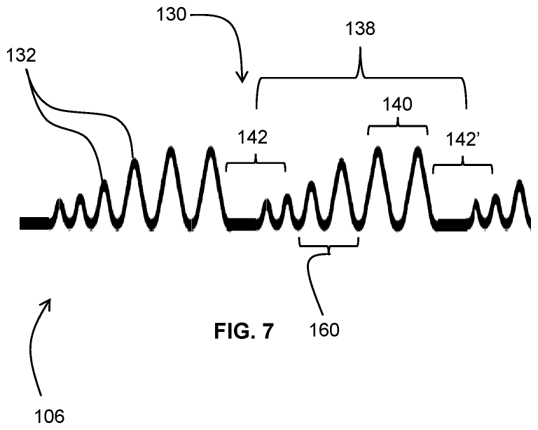

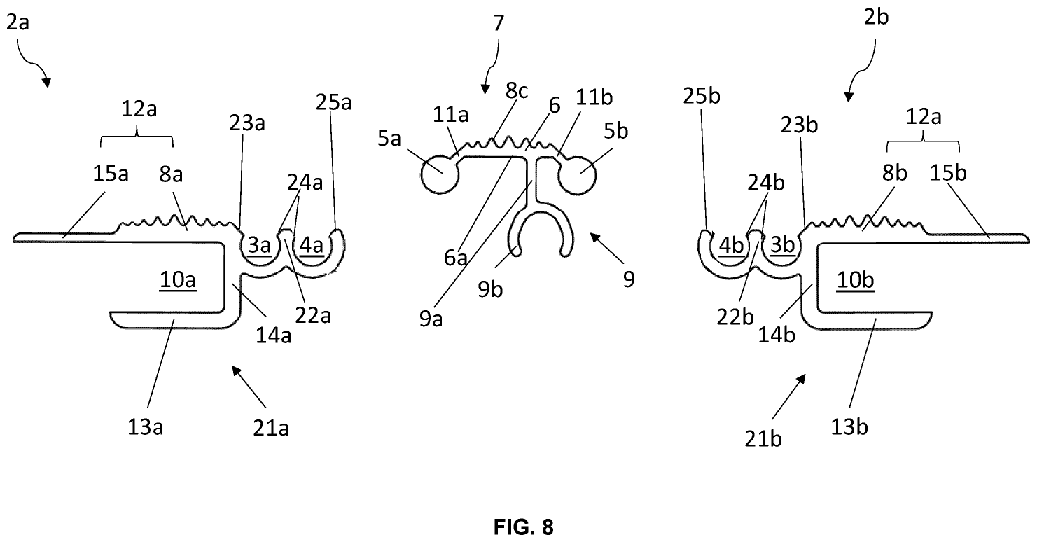

FIGS. 5 and 6 shows an alternative embodiment of the ramp panel 106 according to the present disclosure. In particular, this embodiment illustrates a different arrangement of the plurality of ridges 132 that may be provided on the upper surface 130 of the ramp panel 106. For this reason, only part of the ramp panel 106 is shown and described. It can be assumed that the ramp panel 106 may otherwise be as described above (and for this reason, corresponding reference numerals have been used).

According to this exemplary arrangement, the plurality of longitudinally-elongated ridges 132 comprise a substantially triangular transverse cross-sectional profile. An apex of the triangular cross-sectional profile defines the upper face 136. Accordingly, the upper face 136 forms a face which extends along the longitudinal direction Lr of the ridge 132, but does not extend substantially in the transverse direction Tr.

It is noted that, according to this exemplary arrangement, the troughs 134 are each configured with a substantially curved, concave transverse cross-sectional profile. Accordingly, the trough base 144 is defined by the lowest point in the curve of the trough 134 (instead of the substantially planar trough bases 144 shown in FIG. 3).

The transverse undulating profile 138 of the ramp surface 104 shown in FIG. 5, is defined by a generally (i.e. monotonically) rising and falling sequence of adjacent ridges 132. FIG. 6 shows a detailed sectional view of half the repeated section of the undulating profile 138 shown in FIG. 5 (as indicated by the dotted rectangle labelled C). In particular, this FIG. 6 illustrates the gradual (i.e. monotonic) changes in the depths and widths of the ridges 132 in the transverse direction Tr.

As described above, each of ridges 132 are configured such that they have different heights. That is, the upper faces 136 of adjacent ridges 132 are spaced apart in the depth/height direction from each other. Furthermore, the difference in the heights of each of the respective upper faces 136 is determined relative to the lower surface 126 of the ramp panel.

The exemplary arrangement shown in FIG. 6, shows a sequence of 5 ridges 132. The heights of the first (H1), second (H2), third (H3), fourth (H4), and fifth (H5) ridges are approximately 2 mm, 1.5 mm, 1 mm, 0.5 mm, and 0.4 mm, respectively. Accordingly, the ratio of the height of the fourth ridge (H4) to the height of the fifth ridge (H5) is 5:4 (i.e., the minimum change in height between two adjacent ridges). The ratio of the height of the first ridge (H1) to the height of the second ridge (H2) 4:3 (i.e., the maximum change in height between two adjacent ridges).

Each ridge 132 has a corresponding maximum width in the transverse direction Tr. According to the exemplary arrangement, the widths vary in the transverse direction. For example, the widths (W1-W5) of the ridges 132 gradually reduce in the transverse direction Tr as the depths (D1-D5) of the ridges 132 also decrease. It is also noted that the spacing between the ridges 132 (i.e., measured between the maxima of each ridge 132) effectively reduces in the transverse direction Tr due to the corresponding reduction in the ridge widths (W1-W5).

The widths of the first (W1), second (W2), third (W3), fourth (W4), and fifth (W5) ridges are approximately 2.2 mm, 1.8 mm, 1.4 mm, 1.1 mm, and 1 mm, respectively. Accordingly, the ratio of the width of the fourth ridge (W4) to the width of the fifth ridge (W5) is 11:10 (i.e., the minimum change in width between two adjacent ridges). The ratio of the width of the first ridge (D1) to the width of the second ridge (W2) is 11:9 (i.e., the maximum change in width between two adjacent ridges).

It will be appreciated that the depth and/or width of the, or each trough 134 may be configured to vary in a substantially similar manner to that described above in relation to the plurality of ridges 132, and the spacing between adjacent troughs 134 may also vary accordingly.

Such an arrangement may lend itself to manufacture of the ramp panel by way of an extrusion process (e.g. a single step extrusion process). Once the panel 106 (i.e., including the plurality of ridges 132) has been extruded, a series of notches may be formed along the length of each notch by way of a knurling process.

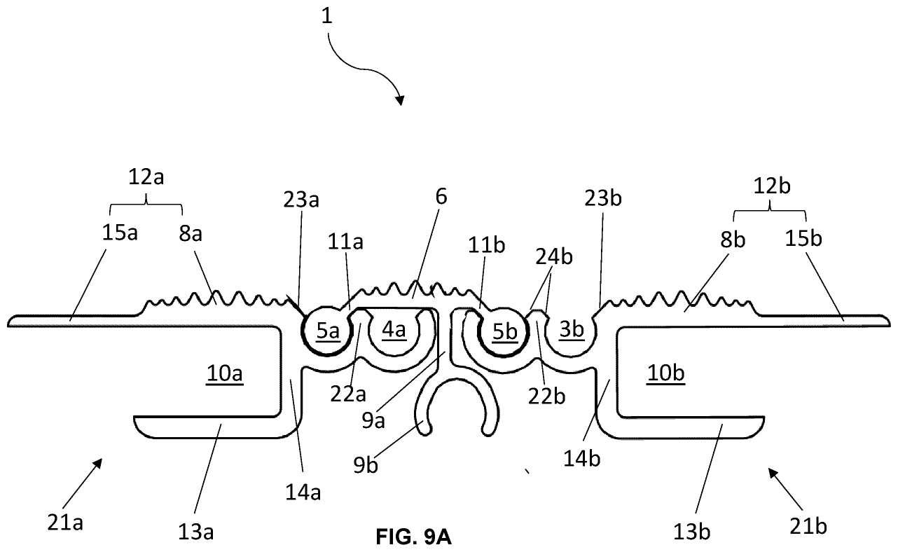

FIG. 7 illustrates a further alternative ramp panel 106 having, again, a different arrangement of the plurality of ridges 132 that may be provided on the upper surface 130 of the ramp panel 106. For this reason, only part of the ramp panel 106 is shown and described. It can be assumed that the ramp panel 106 may otherwise be as described above (and for this reason, corresponding reference numerals have been used).

The illustrated ramp panel 106 has a different undulating profile 138 (defined between first 142 and second 142′ valley regions) to that previously described. Unlike that previously described, the undulating profile 138 of FIG. 7 does not have a smooth transition from the peak region 140 to the second valley region 142′. Instead, there is a sharp/sudden transition between the peak region 140 and the second valley region 142′ because no transition region is interposed therebetween (while the transition between the first valley region 142 and the peak region 140 remains gradual and smooth because a transition region 160 is interposed between these regions). In other words, the second valley region 142′ immediately follows the peak region 140 and thus a primary ridge of maximum height in the peak region 140 is adjacent a tertiary ridge of minimum height in the second valley region 142′ without an ridge of intermediate height interposed therebetween. In this way, the resulting undulating profile 138 is asymmetric (about the peak region 140).

This undulating profile 138 has similar benefits to the previously described wave profiles (e.g. it provides variation in pressure applied at various points to improve traction). Additionally, the asymmetric undulating profile 138 can increase grip due to the large and sudden step between the peak region 140 and the second valley region 142′. This step can especially aid in providing grip for a wheel, foot or shoe that is climbing the ramp panel 106.

The above arrangements of the ramp and ramp panels have been described by way of example. Modifications of the above arrangements will be apparent to skilled persons on reading this disclosure and as such are within the spirit and scope of the invention.

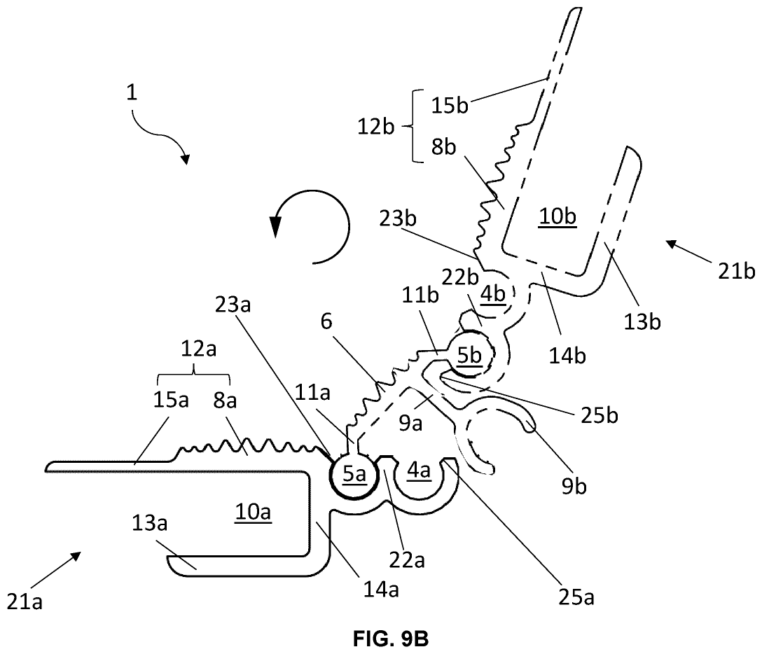

FIG. 8 is a transverse cross-sectional view of components of a hinge system 1 according to an embodiment of the present disclosure. The hinge system 1 has a first ramp connector 2a, a second ramp connector 2b, and a hinge portion 7 which, in-use is interposed between the ramp connectors 2a, 2b.

In this example, the ramp connectors 2a, 2b are identical. Each of the ramp connectors 2a, 2b has a respective longitudinally-extending connector body 21a, 21b and a pair of adjacent longitudinally-extending channels 3a, 3b; 4a, 4b. For example, the first ramp connector 2a has a first connector body 21a, a first inner channel 3a and an adjacent first outer channel 4a. The first connector body 21a has a first longitudinally-extending recess 10a for receiving an inner transverse edge of a first ramp panel, the first recess 10a being defined by a first upper portion 12a (formed of a ridged portion 8a and a transverse extension 15a), a first lower portion 13a, and a first side portion 14a. By virtue of being identical to the first ramp connector 2a, the second ramp connector 2b also has a longitudinally-extending second connector body 21b including a longitudinally-extending second recess 10b for receiving an inner transverse edge of a second ramp panel, the second recess 10b being defined by a second upper 12b, a second lower 13b, and a second side 14b portions. The second ramp connector 2b further has a second inner channel 3b, and an adjacent second outer channel 4b.

The features of the first ramp connector 2a will now be described in detail but it will be appreciated that this discussion equally applies to the features of the second ramp connector 2b.

The first connector body 21a (i.e. the first upper portion 12a, first lower portion 13a and first side portion 14a) and the first inner 3a and outer 4a channels are preferably all integrally formed, e.g. of aluminium and/or by extrusion moulding.

The first upper portion 12a is, in use, proximal a ramp surface of the first ramp panel (not shown) i.e. proximal the surface over which the user travels in use. The first ridged portion 8a comprises a series of longitudinally-extending, transversely spaced ridges. The first transverse extension 15a extends transversely from the first ridged portion 8a. The first transverse extension 15a is substantially planar and has a reduced depth (in a direction perpendicular to both the first transverse extension and the longitudinal extension) compared to the first ridged portion 8a. The first lower portion 13a extends (longitudinally and transversely) substantially parallel to the upper portion 12a. The first lower portion 13a is, in use, proximal a lower surface of the first ramp panel (not shown) i.e. distal the surface over which the user travels in use.

The first ramp connector 2a is configured such that the first upper portion 12a has a greater transverse extension than the first lower portion 13a. Furthermore, the first upper 12a and first lower 13a portions are spaced in a depth direction (i.e. in a direction perpendicular to both the transverse extension and the longitudinal extension of the upper/lower portions) by the first side portion 14a. The first side portion 14a is integral with first inner channel 3a. The first recess 10a is defined by a face of the first side portion which opposes the face of the first side portion integral with the first inner channel 3a. The first recess 10a extends substantially parallel to the first inner 3a and outer 4a channels.

The first inner and outer channels 3a, 4a are aligned with each other in a common plane. Each channel 3a, 4a has a substantially semi-circular transverse cross sectional profile (transverse to the longitudinal axis of the respective channel) and a respective longitudinally-extending channel opening. In this example, the channels 3a, 4a are identical, and each have a diameter larger than the transverse dimension of its respective channel opening. In this way, the first hinge pin 5a can be retained within the respective channel 3a by a snap fit engagement. Preferably, each channel 3a, 4a has a diameter of 6.15 mm or less, and/or a transverse dimension of the respective channel opening of 5.20 mm or less. The first inner 3a and outer 4a channels share a common dividing wall 22a such that an outer wall portion of the first inner channel 3a forms an inner wall portion of the first outer channel 4a.

The first ramp connector 2a has a longitudinally-extending chamfered edge 23a provided on the first upper portion 12a proximal the first inner channel 3a e.g. proximal the join between the first upper portion 12a and the first side portion 14a. A further chamfered edge 24a is provided on the dividing wall between the first inner 3a and outer 4a channels. A yet further chamfered edge 25a is provided on the outer edge of the first outer channel 4a, thereby facing inwards towards the first outer channel opening.

Next, the hinge portion 7 is discussed. The hinge portion 7 comprises identical first 5a and second hinge 5b pins spaced by a longitudinally-extending hinge body 6. The hinge pins 5a, 5b are spherically cylindrical i.e. they have a transverse profile (transverse to their longitudinal extension) that is substantially circular, such that they can be received by the connector channels 3a, 4a, 3b, 4b having the substantially semi-circular transverse cross sectional profile. Preferably, each hinge pin 5a, 5b has a diameter smaller than the diameter of the respective channel 3a, 4b in which it is received and larger than the transverse dimension of the respective channel opening. For example, the diameter of each hinge pin may be 5.50 mm or less. Each hinge pin 5a, 5b has an axial length which substantially matches that of the channel 3a, 4b in which it is received.

The hinge body 6 has an upper surface 8c which, in use, is proximal the ramp surfaces over which the user travels in use. The upper surface 8c is a ridged surface comprising a series of longitudinally-extending, transversely spaced ridges. The hinge body 6 has a lower surface 6a disposed on an opposite side of the hinge body to the upper surface. The lower surface 6a is, in use, proximal the lower surface of the ramp panels i.e. distal the surface over which the user travels in use.

Furthermore, the hinge portion 7 comprises a first longitudinally-extending connecting member 11a connecting the hinge body 6 to the first hinge pin 5a and a second longitudinally-extending connecting member 11b connecting the hinge body 6 to the second hinge pin 5b. The first and second connecting members 11a, 11b each depend substantially downwardly and outwardly from respective opposite transverse edges of the hinge body 6. The connecting members 11a, 11b each have a respective internal surface extending from the lower surface 6a of the hinge body, and a respective external surface extending from the upper surface 8c of the hinge body 6.

The internal surfaces of the connecting members 11a, 11b each form an obtuse angle with the lower surface 6a of the hinge body 6. In this example, each connecting member 11a, 11b depends downwardly at an angle of around 135 degrees from the plane of the lower surface 6c of the hinge body 6. Conveniently, this allows the hinge body 6 to be coplanar with the upper surfaces 12a, 12b of the ramp connectors 2a, 2b in use.

In this example, the hinge portion 7 (i.e. its lower surface) is integral with a handle holder 9. In use, the handle holder extends downwardly away from the lower surface 6a proximal to the second hinge pin 5b. It has a depth dimension (i.e. in a direction perpendicular to the longitudinal and transverse extension of the hinge body) that is less than the depth dimensions of the first 21a and second 21b connector bodies so that the handle holder 9 is entirely within a space defined between the connector bodies.

The handle holder 9 has a gripping portion 9b and a stem portion 9a connecting the gripping portion to the hinge body 6. The stem portion 9a extends longitudinally at least partially along the hinge body 6. The gripping portion 9b comprises a longitudinally-extending channel having a longitudinally-extending opening for receiving and gripping a handle e.g. by crimping of the gripping portion 9b around a portion of the handle. Thus, the gripping portion 9b has a substantially semi-circular transverse cross-sectional profile.

The handle holder 9, the hinge pins 5a, 5b, the connecting members 11a, 11b, and the hinge body 6 are preferably integrally formed, e.g. of metal such as aluminium and/or for example by extrusion moulding.

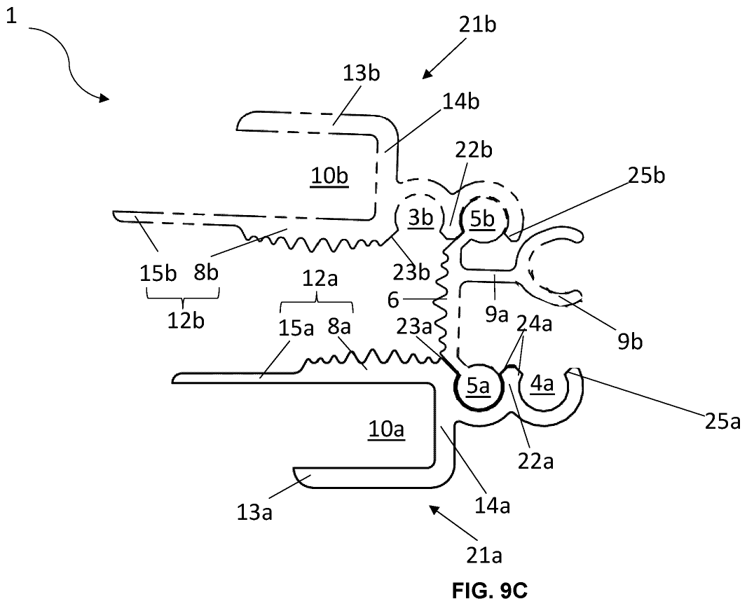

Next, FIGS. 9A to 9C show front sectional views of the assembled hinge system 1 transitioning from an open configuration to a closed configuration.

In the open configuration (shown in FIG. 9A), the hinge portion 7 is interposed between the first 2a and second 2b ramp connectors such that the first hinge pin 5a is received in the first inner channel 3a via its respective channel opening and the second hinge pin 5b is received in the second outer channel 4b via its respective channel opening. The first and second ramp connectors 2a, 2b are arranged such that the first 4a and second 4b outer channels are adjacent each other and interposed between the first 3a and second 3b inner channels. The first and second ramp connectors 2a, 2b are further substantially coplanar i.e. the longitudinal axes of the channels 3a, 4a of the first ramp connector 2a and the channels 3b, 4b of the second ramp connector 2a are substantially coplanar and parallel. The first 10a and second 10b recesses are also coplanar. The upper portions 12a, 12b of the first and the second ramp connectors 2a, 2b, and the upper surface of the hinge body 6 are substantially coplanar. The lower portions 13a, 13b of the first and the second ramp connectors 2a, 2b are coplanar. The internal surface of the first connecting member 11a abuts the chamfered edge 24a of the dividing wall of the first channels 3a, 4a proximal the first inner channel 3a, while the internal surface of the second connecting member 11b abuts the chamfered edge 24b of the second outer channel 4b.

The handle holder 9 is located between the first and second ramp connectors 2a, 2b i.e. between the first and second connector bodies 21a, 21b. In particular, the handle holder 9 extends between the outer channels 3b, 4b of the ramp connectors 2a, 2b no further than the side portions 14a, 14b of the connector bodies 21a, 21b in a depth direction.

Turning to FIG. 9B, to move the hinge system 1 to the closed configuration, the hinge pins 5a, 5b pivot about their respective longitudinal axes inside the respective channels 3a, 4b. In FIG. 9B, each hinge pin 5a, 5b pivots in an anticlockwise direction by about 90 degrees. The hinge system 1 has fully transitioned to the closed configuration once the external surface of the first connecting member 11a abuts the chamfered edge 23a on the first connector body 21a and the external surface of the second connecting member 11b abuts the chambered edge of the dividing wall 24b between the second channels 3b, 4b facing the second outer channel 4b.

In the closed configuration (shown in FIG. 9C), the hinge body 6 is moved into a position where it is substantially normal to the upper surfaces 12a, 12b of the ramp connectors 2a, 2b and where the ramp connectors face each other with the first inner channel 3a and second inner channel 3b transversely off-set.

Furthermore, in the closed configuration, the upper surfaces 12a, 12b of the connector bodies 21a, 21b face each other and lie in parallel planes spaced from each other in a direction that is perpendicular to both the longitudinal and transverse elongation of the channels 3a, 4a, 3b, 4b. The upper surfaces 12a, 12b are spaced by the hinge body 6 of the hinge portion 7. The second outer channel 4b substantially overlies the first inner channel 3a, while the second inner channel 3b overlies the ridged portion 8a of the first connector body 21a. In this way, the first 3a and second 3b inner channels are transversely off-set rather than aligned. The first and second recesses 10a, 10b are also transversely off-set. This transverse off-setting of the connector bodies 21a, 21b in the closed configuration means that any ramp panels connected thereto are also transversely off-set in the closed configuration so that any kerbs on the outer transverse edges of the ramp panels can be off-set and nested.

Further, in the closed configuration, the handle holder 9 is exposed such that the gripping portion 9b extends beyond the second channels 3b, 4b in a direction parallel with the upper surfaces 12a, 12b of the connector bodies 21a, 21b, such that a user can conveniently access the gripping portion 9 e.g. to attach a handle 16 thereto.

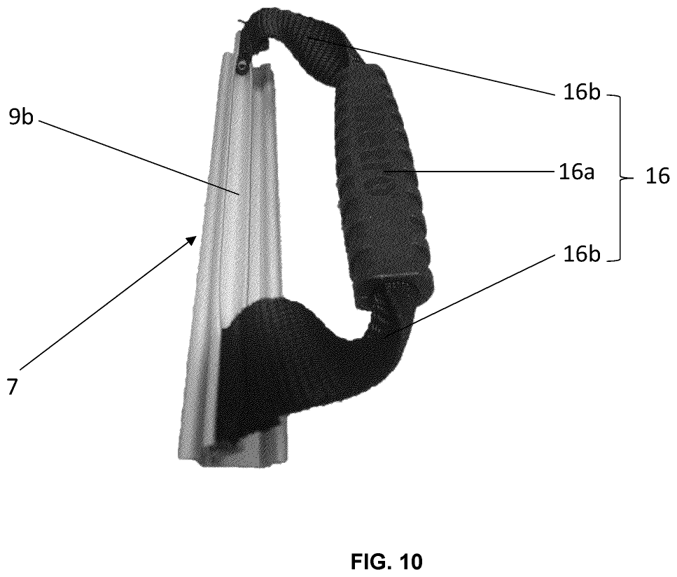

FIG. 10 is a bottom view of the handle holder 9 and a handle 16. The handle 16 comprises a handle grip portion 16a interposed between handle webs 16b. The handle grip portion 16a in this example is formed of a plastics material e.g. a hard plastics material. The handle webs 16b in this example are flexible webs e.g. formed of a woven textile material. The handle webs are inserted within and gripped by the gripping portion 9a of the handle holder 9.

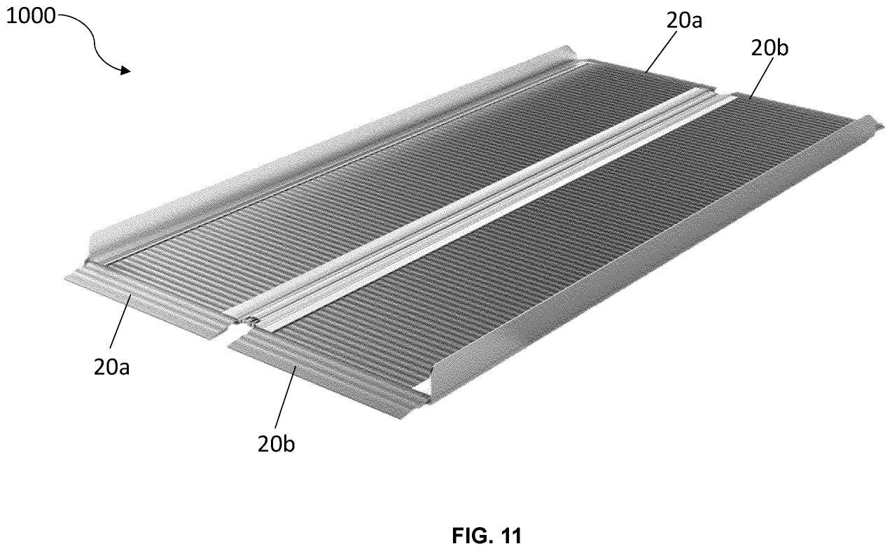

Next, turning to FIG. 11, a foldable ramp 1000 having the hinge system 1 as configured in FIG. 9A is shown. The ramp has a first ramp panel 17a, a second ramp panel 17b and the hinge system 1. The first and second ramp panels 17a, 17b each have a respective inner transverse edge, a respective outer transverse edge, and respective longitudinally spaced lateral ends. The first and second ramp panels 17a, 17b further have respective first and second ramp surfaces, i.e. the surfaces over which the user travels in use. The hinge system 1 is interposed between the respective inner transverse edges of the ramp panels. The ramp 1000 further comprises a first 19a and a second 19b identical kerbs attachable to the outer transverse edges of the ramp panels and two pairs of identical lip portions 20a, 20b attachable to the lateral ends of the ramp panels. The lip portions 20a, 20b have lip surfaces over which the user travels in use.

In this example, the first 17a and second 17b ramp panels are identical. The features of the first ramp panel 17a will now be described in detail but it will be appreciated that this discussion equally applies to the features of the second ramp panel 17b.

The inner transverse edge of the first ramp panel 17a is received by the first recess 10a of the first connector body 21a of the hinge system 1. The first ramp surface and the lip surfaces of the lip portions 20a, 20b attached to the first ramp element 17a comprise a series of transversely-extending, longitudinally spaced ridges (perpendicular to the direction of travel of the user on the ramp).

The first kerb 19a has a first kerb portion upstanding perpendicularly from the first ramp surface and a first kerb connector comprising a longitudinally-extending kerb recess. The first kerb portion and the first kerb connector are integrally formed as a single piece, e.g. of aluminium and/or by extrusion moulding. The outer transverse edge of the first ramp panel 17a is received by the kerb recess and thus the first ramp panel is connected to the first kerb connector. The first kerb connector may have a lower kerb portion, an upper kerb portion, and a side kerb portion defining the kerb recess. The upper, lower, and side kerb portions can be arranged similarly to the upper, lower, and side portions of the first connector body 21a. In particular, the lower kerb portion may extend substantially parallel to the upper kerb portion. The lower kerb portion may, in use, be proximal the lower surface of the first ramp panel i.e. distal the first ramp surface. The upper and lower kerb portions of the first connector portion may be spaced by the side kerb portion. The connector portion of the kerb (i.e. the upper kerb portion, lower kerb portion and side kerb portion) are preferably all be integrally formed, e.g. of metal such as aluminium and/or are extrusion moulded.

A lip portion 20a is connected to each lateral end of the first ramp panel 17a. Each lip portion is inclined with respect to the first ramp 17a surface such that it extends downwards in an in-use depth direction. The lip portion 20a can be integrally formed with the ramp panel or detachably connected to it. For example, the lip portion 20a may include a transversely-extending lip recess formed in a similar or identical manner to the kerb recess described above, such that the respective lateral edge of the first ramp panel 17a is received by the lip recess. Each lip portion 20a, 20b is preferably moulded as a single piece, e.g. of metal such as aluminium and/or by extrusion moulding.

As shown in FIG. 11, when the hinge system 1 is in the open configuration, the ramp 1000 is unfolded such that the ramp panels 17a, 17b are substantially coplanar with the hinge body 6 of the hinge portion 7, and the kerb portions of the first 19a and second 19b kerbs are substantially parallel.

When the hinge system 1 transitions to the closed configuration, as shown in FIGS. 2B and 2C, the foldable ramp 1000 simultaneously transitions to a folded ramp configuration (not shown). In the folded ramp configuration, the ramp panels 17a, 17b are substantially parallel and transversely off-set, while the ramp surfaces face each other. The inner transverse edges of the ramp panels are mutually transversely off-set and so are the outer transverse edges. The kerb portions of the kerbs 19a, 19b are substantially parallel and transversely off-set such that they nest against each other. The kerb portions are also substantially parallel to the hinge body 6.

The ramp panels 17a, 17b are preferably manufactured using the same manufacturing equipment, e.g. the same extrusion die. For example, the ramp panels may be formed as respective single pieces from sheets of metal, such as aluminium, e.g. by extrusion moulding.

The foldable ramp 1000 may be assembled by fitting the inner transverse edge of the first ramp panel 17a into the first recess 10a of the first ramp connector 2a, fitting the inner transverse edge of second ramp panel 17b into the second recess 10b of the second ramp connector 2b, fitting the first hinge pin 5a into the first inner channel 3a of the first ramp connector, and fitting the second hinge pin 5a into the second outer channel 4b of the second ramp connector 2b. Additionally, the outer transverse edges of the ramp panels 17a, 17b may be inserted respectively into the first and second kerb recesses and/or the lateral ends of the ramp panels may be inserted into the lip recesses of the respective lip portions 20a, 20b. Furthermore, the handle 16 may be fitted into the gripping portion 9b of the handle holder 9, e.g. in the manner described in FIG. 10.

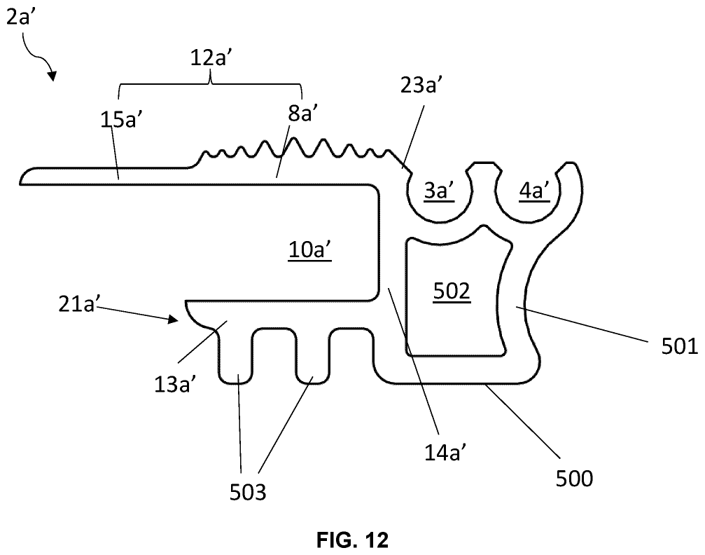

FIG. 12 shows a reinforced first ramp connector 2a′. The second ramp connector may be similarly reinforced.

A transverse reinforcing rib 500 extends from the junction between the first lower portion 13a′ and first side portion 14a′ of the first connector body 21a′. This transverse reinforcing rib 500 is joined to the first outer channel 4a′ by an upwardly-depending rib 501. The first inner and outer channels 3a′, 3b′, first side portion 14a′, transverse reinforcing rib 500 and upwardly depending rib 501 define a longitudinally-extending box structure 502. The upwardly-depending rib 501 curves inwardly into the box structure 502. The box structure reinforces the first connector member 2a and protects the outer channel 4a′ in particular from damage or distortion.

The first lower portion 13a′ may further comprise a plurality of longitudinally-extending strengthening ribs 503.

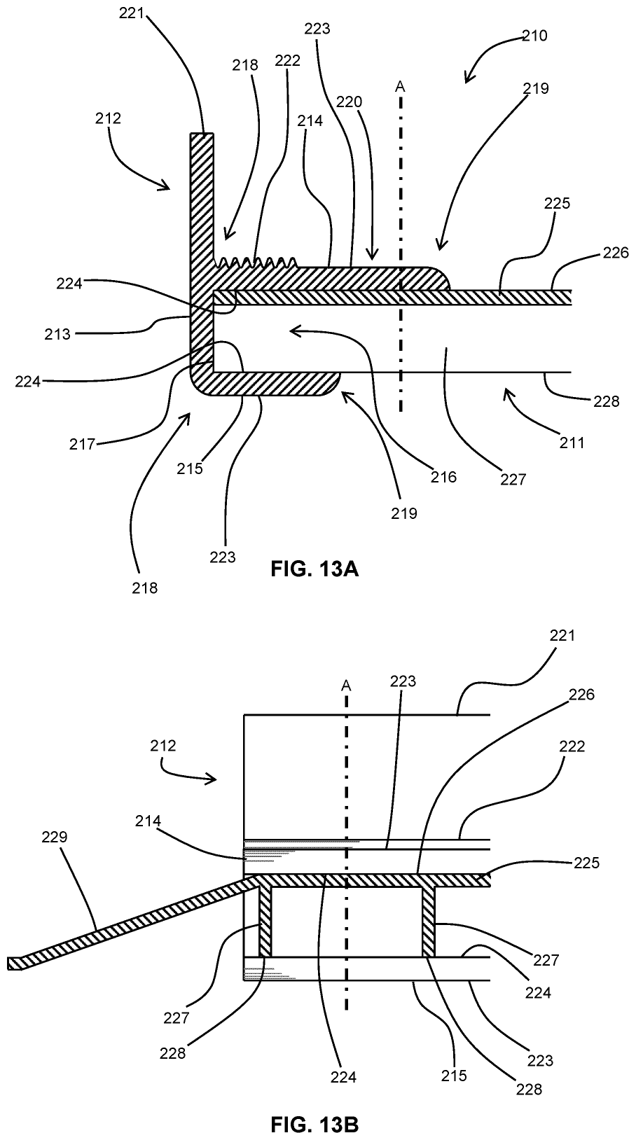

FIG. 13A illustrates a portion of a ramp 210 comprising a ramp member 211 and a ramp kerb 212. The ramp 210 is a portable ramp that can be used to provide access (e.g. wheelchair access) between surfaces at two different heights.

The ramp kerb 212 comprises a longitudinally extending spine 213, and first (upper) 214 and second (lower) 215 flanges projecting laterally from the spine 213. The flanges 214, 215 are spaced from one another (in the vertical direction as illustrated) so as to define a channel 216 therebetween. A longitudinally extending edge 217 of the ramp member 211 is received in (and supported in) this channel 216.

Each flange 214, 215 extends from a proximal end 218, joined to the spine 213, to an opposite distal (free) end 219. Each flange 214, 215 has an external surface 223 that faces away from the other of the flanges 214, 215 (i.e. faces outwardly) and an internal surface 224 that faces inwardly towards the other of the flanges 214, 215. The external surface 223 of the first flange 214 is an upper surface of the first flange 214.

As should be apparent from FIG. 13A, the first flange 214 is wider than the second flange 215. Specifically, in the present embodiment, the first flange 214 has a width of about 32 mm and the second flange has a width of about 16 mm. Thus, a planar distal end portion 220 of the first flange 214 projects laterally beyond the distal end 219 of the second flange 215 by about 16 mm. As a result of this, and because the distal end portion 220 represents an uppermost part of the ramp kerb 212 (e.g. there is no structure positioned above the end portion 20), an axis A passing through the distal end portion 220 of the first flange 214 (that is perpendicular to the lateral extension of the first flange 214) does not intersect with any portion of the ramp kerb 212 other than the first flange 214.

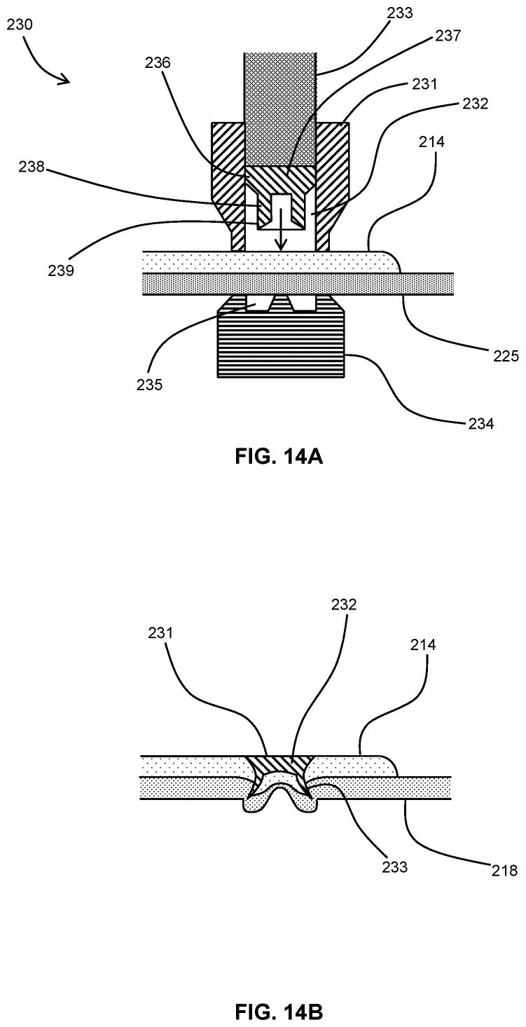

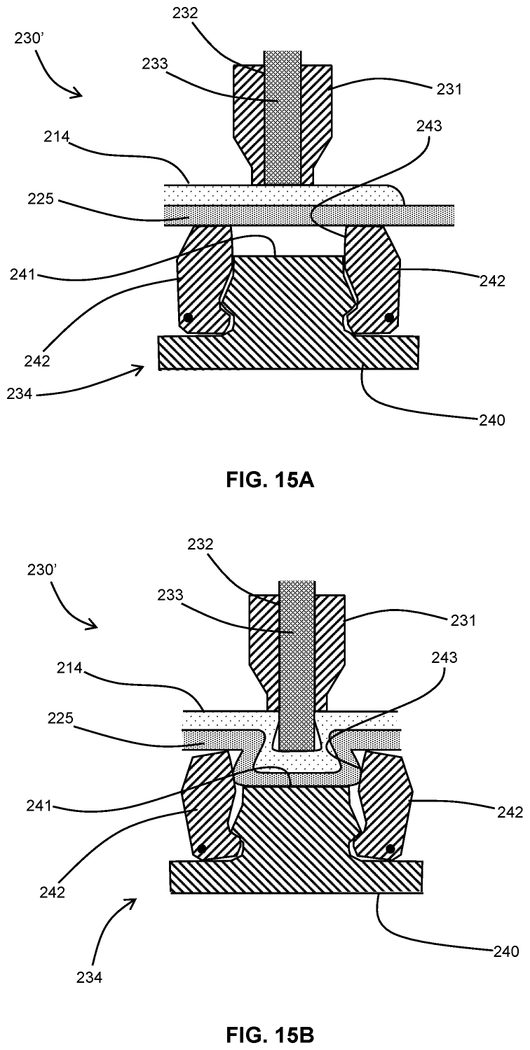

One benefit of such an arrangement is that it allows fixing of the ramp member 211 to the ramp kerb 212 by methods that require access to both sides of the workpieces (in this case, the first flange 214 and the ramp panel 218) to be fixed. Such methods will be described in detail further below (with respect to FIGS. 14A, 14B, 15A and 15B).

The ramp kerb 212 further comprises a rail 221 upstanding from the spine 213 (so as to form an extension of the spine 213). The rail 221 acts as a safety feature in that it helps to prevent e.g. a wheel of a wheelchair or pram/pushchair from travelling off the edge of the ramp 210. A further safety feature of the ramp kerb 212 is a plurality of laterally spaced, longitudinally extending ridges 222, which extend along the external upper surface 223 of the first flange 214 proximate to the rail 221. The ridges 222 provide additional grip to the external upper surface 223 of the first flange 214 and are spaced away from the distal end portion 220 of the first flange 214 so as not to interfere with the fixing process.

The ramp kerb 212 has a constant cross-sectional shape for its entire longitudinal length. This means that the ramp kerb 212 can be formed by way of an extrusion process.

The ramp member 211 comprises a planar ramp panel 225, an upper surface 226 of which supports a user of the ramp 210 in use. The ramp member 211 also includes a plurality of support legs 227 that are integrally formed with the ramp panel 225 and that extend laterally across an underside of the ramp panel 225. Each support leg 227 extends downwardly from the ramp panel 225 (perpendicularly to the ramp panel 225) to a distal (i.e. lower) end 228.

At one (longitudinal end) the ramp member 211 is provided with a ramp lip 229 that is angled with respect to the ramp panel 225 so as to facilitate movement by a user onto the panel 225 (i.e. the lip 230 provides for transition onto the ramp panel 225).

The edge 217 of the ramp member 211 (received in the channel 216) is therefore formed by a combination of the legs 227 and the ramp panel 225. In particular, the height of the ramp member 211 (i.e. taken from the upper surface 226 of the ramp panel 225 to the distal end 228 of each leg 227) is substantially the same as the height of the channel 216. In this way, the upper surface 226 of the ramp panel 225 abuts the internal (lower) surface 224 of the first flange 214, and the distal ends 228 of the legs 227 abut the internal (upper) surface 223 of the second flange 215. This close fit between the ramp member 211 and the ramp kerb 212 helps to provide a secure connection therebetween.

The open arrangement of the lower part of the ramp member 211 (e.g. that no lower panel is provided extending across the distal ends 228 of the legs 227, such that the distal ends 228 are free ends) allows for access to an underside of the ramp panel 225. Such access is also facilitated by the spacing of the legs 227 of the ramp member 211. Between each pair of neighbouring legs 227 there is a portion of the ramp panel 225, adjacent to the distal end portion 220 of the first flange 214, that is open to an underside of the ramp member 211. In this way, the abovementioned axis A intersects only the ramp panel 225 of the ramp member 211 (i.e. no other portion of the ramp member 211 is intersected by the axis A). Accordingly, only the first flange 214 and the ramp panel 225 of the ramp 210 (i.e. the two parts of the ramp 210 to be fixed) are intersected by the axis A.

As already discussed above, such an arrangement allows the ramp 210 to be assembled using a process in which both sides of the workpieces (in this case the first flange 214 and the ramp panel 225) must be accessible. One such fixing process is exemplified by FIGS. 14A and 14B, which illustrate a self-piercing rivet fixing process that can be used to fix the ramp member 211 to the ramp kerb 212.

For clarity, in these figures only a portion of each of the ramp panel 225 and the first flange 214 are shown. In FIG. 14A, a fixing device 230 is shown, which comprises a body 231 having an internal bore 232 along which a punch (or plunger) 233 can be driven. The body 231 is disposed on the upper surface of the first flange 214. On the underside of the ramp panel 225, the device 230 includes a die 234 having an annular recess 235. A self-piercing rivet 236 is loaded in the bore 232 of the device 230, at a lower end of the punch 233. The rivet 236 (which is generally cylindrical) includes an enlarged portion 237 at an upper end thereof and a cutting portion 238 projecting downwardly from the enlarged portion 237. The cutting portion 238 includes an annular cutting edge 39 that is coincident with the annular recess 235 of the die 234.

In use, the punch 233 is driven along the bore 232 towards the first flange 214 such that the cutting edge 239 impacts and pierces the first flange 214. As this occurs, the rivet 236, the first flange 214 and the ramp panel 225 are caused to deform. This is shown in FIG. 14B. As is apparent from this figure, the cutting portion 239 of the rivet 236 splays outwardly. This, along with the deformation of the first flange 214 and the ramp panel 225, fixes the ramp panel 225 to the flange 214.

As may be appreciated, because this method of fixing can be performed in a single movement and does not require a hole to be pre-formed in the first flange 214 and/or the ramp panel 225, it can be particularly cost effective.

An alternative fixing device 230′ is illustrated in FIGS. 15A and 15B. This is a clinching fixing device 230′ and include similar feature to that of FIGS. 14A and 14B (the same reference numerals have been used for corresponding features).

The device 230′ includes a body 231 defining a bore 232 in which a punch 233 is received, and along which the punch 233 can be driven. The device body 231 is disposed on an upper surface of the first flange 214 (that, in turn, overlies the ramp panel 225).

A die 234 is positioned on an underside of the ramp panel 225 so as to oppose the body 231. The die 231 includes a die body 240 having an upper forming surface 241. The die 234 further includes moveable (in this case pivotable) arms 242 that are pivotably mounted to the die body 240. Each arm 242 includes an inwardly facing side forming surface 243.

In operation (as can be understood from FIG. 15B), the punch 233 is driven along the bore 232 and into the first flange 214. This deforms the first flange 214 and the ramp panel 225 so as to be forced against the upper forming surface 241 and the side forming surfaces 243. As the punch 233 is driven, the arms 242 of the die 234 move outwardly in a controlled manner, and this helps to shape the deformed portions of the first flange 214 and the ramp panel 225. In particular, the resulting shape of these portions is such that a deformed portion of the first flange 214 splays outwardly and is enveloped by a deformed portion of the ramp panel 225. This results in the first flange 214 and ramp panel 225 being fixed together.

As should be appreciated, this process has the same benefits as that described above with respect to FIGS. 14A and 14B, and further avoids the need to provide any fastener (i.e. therefore reducing complexity and cost). The arrangement of the ramp 210, being such that it is suited to these two fixing methods, therefore makes the ramp faster and cheaper to assemble.

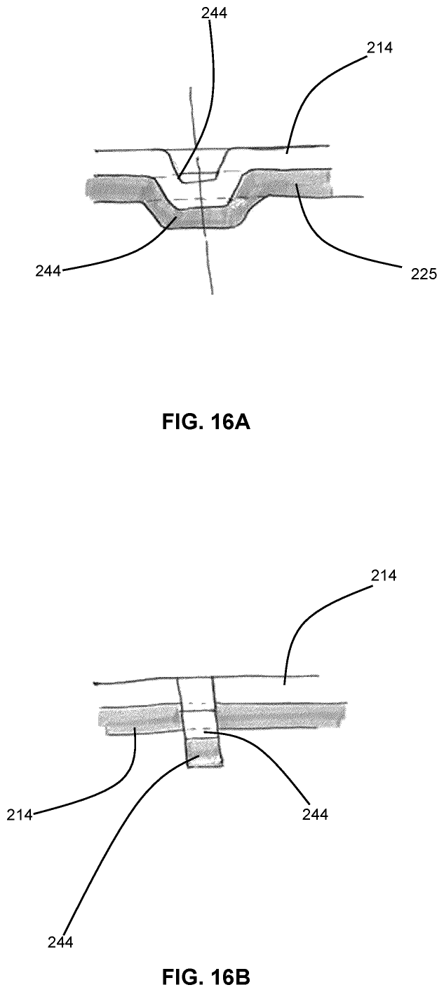

FIGS. 16A and 16B provide a further example of how the first flange 214 and ramp panel 225 may be fixed via clinching process. In this case, the fixing has been formed with a static die (i.e. a die not including moveable parts such as arms). The die and punch (not shown) are configured so as to both shear and deform portions of the first flange 214 and the ramp panel 225. The result is overlying strips 244 that are deformed and sheared away from the plane of the first flange 214 and ramp panel 225, but that each remain connected at opposed ends to the respective one of the first flange 214 and ramp panel 225. As should be appreciated, this fixing prevents in-plane movement between the first flange 214 and ramp panel 215 but not movement of the ramp panel 225 away from the first flange 214. This type of fixing may be referred to as half-shear clinching.

The exemplary embodiments set forth above are considered to be illustrative and not limiting. Various changes to the described embodiments may be made without departing from the spirit and scope of the invention.

For example, the positioning of the die and punch as shown in FIGS. 14A-15B can be reversed (e.g. the die can be provided on the first flange and the punch provided on the ramp panel).

Likewise, the clinching arrangement shown in FIGS. 15A and 15B is merely one example of how such clinching could be performed. In other arrangements, for example, the die may not include any moving parts (i.e. may be a static die). Instead, the die may be shaped such that flaring/splaying of the deformed portions of the ramp kerb/ramp member occurs. Alternatively, the clinching device may also be configured to form deformed portions in the ramp kerb and ramp member that do not include any such flaring/splaying. For example, the clinching device may be configured to form a hemispherical protrusion received in a hemispherical recess. As already set forth above, this may be suitable where movement of the ramp member away from the ramp kerb (i.e. in a direction perpendicular to a plane of the ramp member) is otherwise restricted by close receipt of the ramp member between the first and second flanges.

The deformed portions of the first flange and ramp member may take other shapes, for example the half-shear arrangement described above.

Further, the ramp member may be modular and may be formed of a plurality of modules arranged side-by-side (i.e. each module extending laterally). Each module may comprise a ramp panel and one or more legs as described above.

Moreover, the ramp illustrated above is shown only with a single lip. It should be appreciated that the ramps disclosed herein may comprise a lip at only one, or both, ends of the ramp member (i.e. providing easy transition onto the ramp member at each end).

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the invention that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

### CLAUSES

The following numbered paragraphs may be useful in understanding the disclosure herein:

A1. A ramp panel comprising a plurality of longitudinally-elongated ridges spaced in a transverse direction by a plurality of interposed longitudinally-elongated troughs, each ridge having an upper face defining a portion of a ramp surface over which a ramp user can travel, wherein the height of the ridges on the substrate varies such that the upper faces of the ridges provide a ramp surface having a wave profile in the transverse direction.

A2. A ramp panel according to clause A1, wherein the ramp surface comprises a plurality of undulations in the transverse direction.

A3. A ramp panel according to clause A1 or A2, wherein each ridge has a uniform depth along its longitudinal elongation.

A4. A ramp panel according to clause A1 or A2, wherein at least one of the ridges comprises a series of longitudinally-spaced transverse notches and wherein the notches in the series or each series of notches vary in depth along the longitudinal elongation of the respective ridge.

A5. A ramp panel comprising a plurality of longitudinally-elongated ridges spaced in a transverse direction by a plurality of interposed longitudinally-elongated troughs, each ridge having an upper face defining a portion of a ramp surface over which a ramp user can travel, wherein at least one of the ridges comprises a series of longitudinally-spaced transverse notches and wherein the notches in the series or each series of notches vary in depth along the longitudinal elongation of the respective ridge.

A6. A ramp panel according to clause A4 or A5, wherein all of the ridges comprise a respective series of notches.

A7. A ramp panel according to any one of clauses A4 to A6, wherein each notch comprises a respective notch base and wherein the notches within the/each series vary in depth such that the bases of the notches together define a notch wave profile in the longitudinal direction.

A8. A ramp panel according to clause A7, wherein the notch wave profile comprises a plurality of undulations in the longitudinal direction.

A9. A ramp panel according to any one of the preceding clauses, wherein each trough comprises a longitudinally-extending trough base and wherein the trough bases are substantially coplanar.

A10. A ramp panel according to any one of the preceding clauses, wherein the ramp surface defined by the upper faces of the ridges extends over substantially the entirety of one face of the ramp panel.

A11. A ramp panel according to any one of the preceding clauses, wherein the ridges each comprise a substantially triangular transverse cross-sectional profile.

A12. A ramp panel according to any one of the preceding clauses, wherein the transverse spacing between adjacent ridges varies in the transverse direction.

A13. A ramp panel according to any one of the preceding clauses, wherein each of the ridges has a respective maximum width in the transverse direction and the maximum widths of the ridges varies.

A14. A ramp comprising a ramp panel according to any one of the preceding clauses.

A15. A ramp according to clause A14, wherein the ramp panel comprises a first lateral end across which the ramp user enters the ramp and a laterally opposed second lateral end from which the ramp user exits the ramp and wherein the elongated ridges extend in a direction perpendicular to the direction extending between the lateral ends.

1.-46. (canceled)

47. A ramp kerb comprising a longitudinally extending spine and first and second flanges projecting laterally from the spine, the flanges spaced from one another so as to define a channel therebetween for supporting a longitudinally extending edge of a ramp member therein, wherein a distal end portion of the first flange projects laterally beyond a distal end of the second flange, and wherein an axis passing through the distal end portion of the first flange, and that is perpendicular to the lateral extension of the first flange, does not intersect any portion of the ramp kerb other than the first flange.

48. A ramp kerb according to claim 47 wherein the first flange is an in-use upper flange.

49. A ramp kerb according to claim 48 comprise a longitudinally extending rail upstanding from, or proximate to, the first flange.

50. A ramp kerb according to claim 47, wherein the width of the distal end portion of the first flange is at least 10 mm.

51. A ramp kerb according to claim 47, wherein the flanges are integrally formed with the spine.

52. A ramp kerb according to claim 47 that has a constant cross-sectional shape for substantially its entire length.

53. A ramp kerb according to claim 47, wherein opposed surfaces defining the distal end portion of the first flange are substantially planar.

54. A ramp comprising a ramp kerb according to claim 47 and a ramp member having a longitudinally extending edge supported within the channel of the ramp kerb.

55. A ramp according to claim 54, comprising a ramp panel having an upper surface upon which a user may be supported in use and a plurality of legs, each leg projecting downwardly from the ramp panel to a distal free end of the leg.

56. A ramp according to claim 55, wherein each leg extends laterally across the ramp member and wherein the legs are spaced from one another in the longitudinal direction.

57. A ramp according to claim 54, wherein the first flange of the ramp kerb is fixed to the ramp member by way of a plurality of clinch fixings or by way of a plurality of self-piercing rivets.

58. A ramp according to claim 54, wherein the ramp kerb is a first ramp kerb, and the longitudinally extending edge of the ramp member is a first longitudinally extending edge, and wherein the ramp further comprises a second ramp kerb and the ramp member comprises a second longitudinally extending edge, opposite the first longitudinally extending edge, that is supported in a channel of the second ramp kerb.

59. A method of assembling a ramp, the method comprising:
inserting a longitudinally extending edge of a ramp member into the channel of a ramp kerb according to claim 47;
positioning one of a die and a punch on a surface of the distal end portion of the first flange of the ramp kerb;
positioning the other of the die and punch on a surface of the ramp member opposing the surface of the first flange on which the die or punch is positioned; and
actuating the punch to punch and deform the first flange and the ramp member to fix the first flange and the ramp member together.

60. A method according to claim 59, further comprising, when actuating the punch, driving a self-piercing rivet into the first flange and the ramp member to fix the first flange and the ramp member together.
